(19) United States
(12) Patent Application Publication
(10) Pub. No.: US 2025/0383549 A1
(43) Pub. Date: Dec. 18, 2025

(54) METHODS AND DEVICES FOR GENERATING HIGH-DIMENSIONAL STRUCTURE LIGHT

(71) Applicants: THE TRUSTEES OF THE UNIVERSITY OF PENNSYLVANIA, Philadelphia, PA (US); RESEARCH FOUNDATION OF THE CITY UNIVERSITY OF NEW YORK, New York, NY (US)

(72) Inventors: Haoqi ZHAO, Philadelphia, PA (US); Liang FENG, Wynnewood, PA (US); Zhifeng ZHANG, Philadelphia, PA (US); Li GE, Providence, RI (US)

(21) Appl. No.: 19/130,324

(22) PCT Filed: Nov. 16, 2023
(86) PCT No.: PCT/US2023/080018

§ 371 Date: May 15, 2025

Related U.S. Application Data
(60) Provisional application No. 63/425,901, filed on Nov. 16, 2022.

(51) Int. Cl. G02B 27/09

(52) U.S. Cl. CPC G02B 27/0905

(57) ABSTRACT

Methods and devices for generating high dimensional structured light are disclosed herein. In one aspect, a method can include: generating, via a first microring of a microlaser, a first structured light emission having a first degree of freedom and a second degree of freedom; and generating, via a second microring of a microlaser, a second structured light emission having a third degree of freedom and a fourth degree of freedom, wherein an interaction between the first structured light emission and the second structured light emission forms a fifth degree of freedom.

### CROSS-REFERENCE TO RELATED APPLICATIONS

The present application claims priority to and the benefit of U.S. patent application No. 63/425,901, “Methods and Devices for Generating High-Dimensional Structure Light” (filed Nov. 16, 2022), the entirety of which application is incorporated herein by reference for any and all purposes.

### GOVERNMENT RIGHTS

This invention was made with government support under 1932803 and 1842612 awarded by the National Science Foundation and W91NF-21-1-0340, W911NF-21-1-0148 and W911NF-19-1-0249 awarded by the Department of Defense. The government has certain rights in the invention.

### TECHNICAL FIELD

The disclosed technology relates to the field of structured light generation, and in particular, high dimensional structured light.

### BACKGROUND

Structured light can be utilized to carry information within communication systems. Typically, the more degrees of freedom (dimensions) the structured light has, the more information the structured light can carry. Previous techniques to coherently generate high dimensional structured light rely on table-top optical component, including bulk lasers, waveplates, spatial light modulators and spiral phase plates to generate such kind of states. However, the typical equipment is cumbersome, requires manual tuning, and is not scalable.

Additionally, typical equipment is limited to emitting discrete states instead of a superposition among these sates, which, although integrated, cannot fully use the dimensionality of the space. There exists a need for equipment and methods capable of generating structured light with a higher number of dimensions.

### SUMMARY

Methods and devices for generating high dimensional structured light are disclosed herein. In one aspect, a method can include: generating, via a first microring of a microlaser, a first structured light emission having a first degree of freedom and a second degree of freedom; and generating, via a second microring of a microlaser, a second structured light emission having a third degree of freedom and a fourth degree of freedom, wherein an interaction between the first structured light emission and the second structured light emission forms a fifth degree of freedom.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 depicts a hyperdimensional spin-orbit microlaser, according to the present disclosure. (a), Scanning electron microscope (SEM) image of the microlaser fabricated on an InGaAsP multiple quantum well platform, where two microring lasers are coupled through two 3 dB directional couplers (violet), four control waveguides (red), and alongside six heating pads (green). Note that control waveguides 1-4 are paired with their adjacent heating pads 1-4. The strength and phase of the coupling are determined by selective nanosecond pulsed optical pumping on each control waveguide 1-4 for active gain control and continuous-wave optical pumping on its adjacent heating pad 1-4 for thermally induced phase tuning. Heating pads 5 and 6 are implemented to manipulate the frequency detuning between two microring lasers. With strategically designed angular gratings, emissions from two microlasers feature two pairs of spin-orbit-coupled vectorial states, each covering a distinguished HOPS. The coupling between two microrings leads to the coupling between two generated HOPS, forming a Bloch hypersphere defining an SU(4) symmetry in a 4D Hilbert space. (b), SEM image of the 3 dB directional coupler. (c), SEM image of the right microring laser with the angular grating inscribed on the inner side wall. The diameter of the microrings is 7 μm and the width of the waveguide is 650 nm. With the orders of angular gratings being 30/34 for left/right microrings, their emitted vector beams carry spin-orbit-coupled states of |+/−2, ↑/↓> and |−/+2, ↑/↓>, respectively.

FIG. 2 depicts independent emission control on two distinguished HOPS. (a), Phase tuning on HOPS I with two pole states defined as |N₁ [symbol] =|+2, ↑> and |S_{I} [symbol] =|−2, ↓>. The relative phase between two pole states can be dynamically tuned via heating pads 1 and 2, winding along the equator in the azimuthal direction as demonstrated by 4 special states with an equal phase difference of π/2. The upper panel in each rectangle shows captured emission pattern after a horizontally placed linear polarizer, whereas the lower panel maps the measured relative phase between two pole states, both rotating in the same manner with (φ₂−φ₁)/4. (b), Phase tuning on HOPS II with two pole states defined as |N_{II})=|−2, ↑> and |S_{II})=|+2, ↓>, where the relative phase between two pole states is dynamically tuned via heating pads 3 and 4, rotating with (φ₃−φ₄)/4. (c), Chiral control between |N₁ [symbol] and |S_{I} [symbol] on HOPS I, enabled by controlled pumping on control waveguides 1 and 2 in FIG. 1a. Five special states are characterized, where the intensities of the two spin components |+2, ↑> (left) and |−2, ↓> (right) are separately measured, revealing the amplitude ratios between two pole states and thus the state evolution from |N_{I} [symbol] to |S_{I} [symbol] . (d), Chiral control between |N_{II} [symbol] and |S_{II} [symbol] on HOPS II, enabled by controlled pumping on control waveguides 3 and 4 in FIG. 1a. Five special states are characterized, where the intensities of the two spin components |−2, ↑> (left) and |+2, ↓> (right) are separately measured, revealing the state evolution from |N_{I} [symbol] to |S_{I} [symbol] .

FIG. 3 depicts SU(4) Bloch hypersphere by delicate control of inter-ring coupling. (a), Schematic of the formation of a Bloch hypersphere and the SU(4) state control of laser emission. The states on the SU(4) Bloch hypersphere can be represented on a nested HOPS III: Because of intrinsic orthogonality between these two HOPSs, two arbitrary pole states can be selected for HOPS III, one from each HOPS (I or II) and constituting a complete 4D Hilbert space. SU(4) state control is completed on HOPS III by adjusting two DOFs between the two microrings: their relative amplitude and phase, corresponding to state tuning along the latitude and longitude, respectively. (b), Measured chirality control on HOPS III from its south pole to north pole by differential pumping of two microrings. Pumping chirality is defined as (P_{I}−P_{II})/(P_{I}+P_{II}), where P_{I,II} denotes optical pumping power on the left/right ring. Measured chirality is given by (I_{I}−I_{II})/(I_{I}+I_{II}), where I_{I,II} is the intensity of laser emission from the left/right ring. c and d show phase control to move the state along the latitude of HOPS III as a function of the power of the continuous-wave laser applied on heater 5: in (c), state 0.9851|+2, ↑ [symbol] +0.1719e^{0.550 πi}|−2, ↓ [symbol] (at θ₁=0.11π, ϕ₁=0.55π) on HOPS I and state 0.4540|−2, ↑ [symbol] +0.8910e^{1.260πi}|+2, ↓ [symbol] (at θ₂=0.70π, ϕ₂=1.26π) on HOPS II are selected, showing a linear phase variation, whereas in (d), state 0.7705|+2, ↑ [symbol] +0.6374e^{1.940πi}|−2, ↓ [symbol] at (θ₁=0.44π, ϕ₁=1.94π) on HOPS I and state 0.6613|−2, ↑ [symbol] +0.7501e^{0.230πi}|+2, ↓ [symbol] at (θ₂=0.54π, ϕ₂=0.23π) on HOPS II are selected, showing a step-like phase variation on HOPS III attributed to supermode hopping.

FIG. 4 depicts generation and reconfiguration of SU(4) states. (a)-(d), Characterization of a high-dimensional superposition state

$$\vert {ψ}_{1} 〉 = \frac{1}{2} ( \vert + 2 , ↑ > + \vert - 2 , ↓ > + \vert - 2 , ↑ > - \vert + 2 , ↓ > ) ,$$

when equally pumping two microring lasers and 4 control waveguides but selectively conducting the temperature difference between heating pads 3 and 4 appropriately. (a) shows theoretical results of cross-correlation far-field intensity and phase patterns that capture the vectorial nature of ψ₁. (b) displays the corresponding experimentally reconstructed patterns, after image processing to select only the AC component in raw data. (c) and (d) are theoretically calculated vs. experimentally retrieved density matrix of ψ₁, respectively, featuring fidelity of 0.998. (e)-(h), Same as (a)-(d) but for

$$\vert {ψ}_{2} 〉 = \frac{\sqrt{2}}{2} ( \vert + 2 , ↑ > - \vert - 2 , ↑ > ) ,$$

generated by equally pumping two microring lasers but selectively pumping only control waveguides 1 and 4 and thermally tuning heating pad 5 appropriately. e and f capture the non-vectorial nature of |ψ₂ [symbol] . (h) shows experimental fidelity of 0.942 when compared with (g).

FIG. 5 depicts optical setup and spectral characterization of the microlaser. (a), Optical setup for the characterization of the microlaser. (b), Lasing spectrum of the microlaser under a pumping intensity of 25 kW/cm² which shows a robust single mode lasing. (c), Light-light curve of the microlaser.

FIG. 6 depicts chiral control and OAM characterization of spin-orbit-coupled emissions from two microrings by a cylindrical lens. (a), Characterization of OAM emissions from the left microring under different pumping and measurement conditions (g₁>>g₂, g₁=g₂, and g₂>>g₁). (b), Characterization of OAM emissions from the right microring under different pumping and measurement conditions (g₄>>g₃, g₃=g₄, and g₃>>g₄). In both (a) and (b), top, middle and bottom rows show unpolarized, left-handed polarized, and right-handed polarized components of laser emission.

FIG. 7 depicts experimental demonstration of chiral control on HOPS I and II. (a), HOPS I and (b), HOPS II.

FIG. 8 depicts Stoke polarimetry to retrieve the relative phase between two pole states on HOPS. (a), Six polarization states are recorded corresponding to I₀(x, y), I₄₅(x, y), I₉₀(x, y), I₁₃₅(x, y), I_{↑}, and I_{↓} for phase retrieval using the Stokes polarimetry. White arrows denote the direction of polarizations. (b), The retrieved relative phase distribution between |+2, ↑> and |−2, ↓> components, showing 8π phase winding in the azimuthal direction.

FIG. 9 depicts experimental phase tuning in two individual HOPS associated with the left and right microrings. (a), Phase tuning on HOPS I associated with the left microring (ϕ=φ₂−φ₁) under continuous-wave laser heating. Positive/negative heating power here represents heating on heater 1/2, respectively. (b), Phase tuning on HOPS II associated with the right microring (ϕ=φ₃−φ₄) under continuous-wave laser heating. Positive/negative heating power here represents heating on heater 3/4, respectively. The slight difference in slopes in both panels results from small variance in absorption efficiency associated with different heaters.

FIG. 10 depicts controlled frequency detuning in the microlaser. The frequency detuning between the two microrings under different heating power from the continuous-wave laser, showing the increase of the detuning as the increase of heater power.

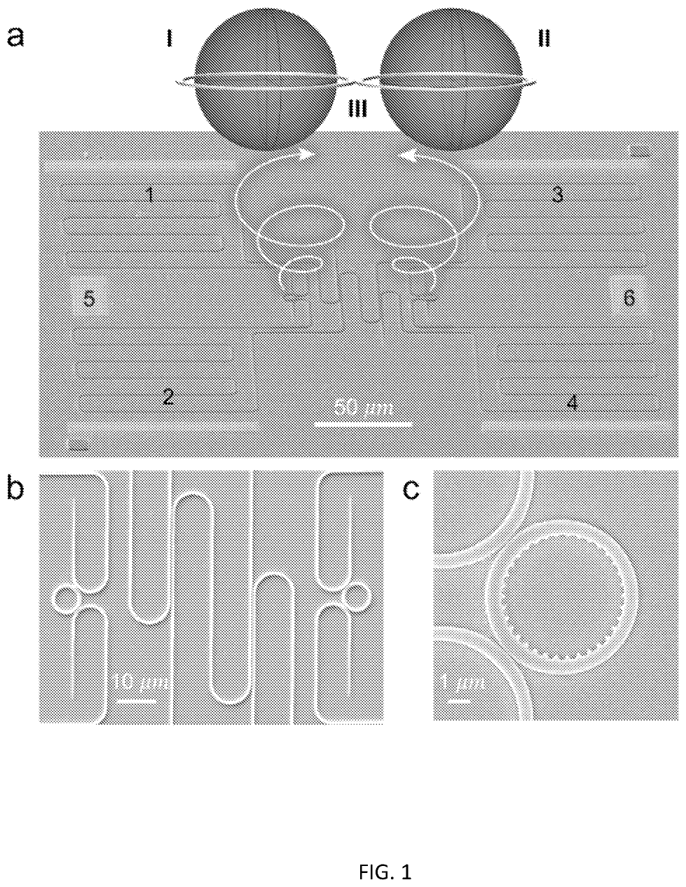

FIG. 11 depicts an SEM picture reproduced from FIG. 1a shows the coupling schematic of the hyperdimensional microlaser array. The two HOPS microrings are coupled with each other through four control arms and two 3-dB directional couplers. Each chiral mode (CW or CCW) in one microring is coupled with both chiral modes in the other microring via the two direction couplers c₁ and c₂.

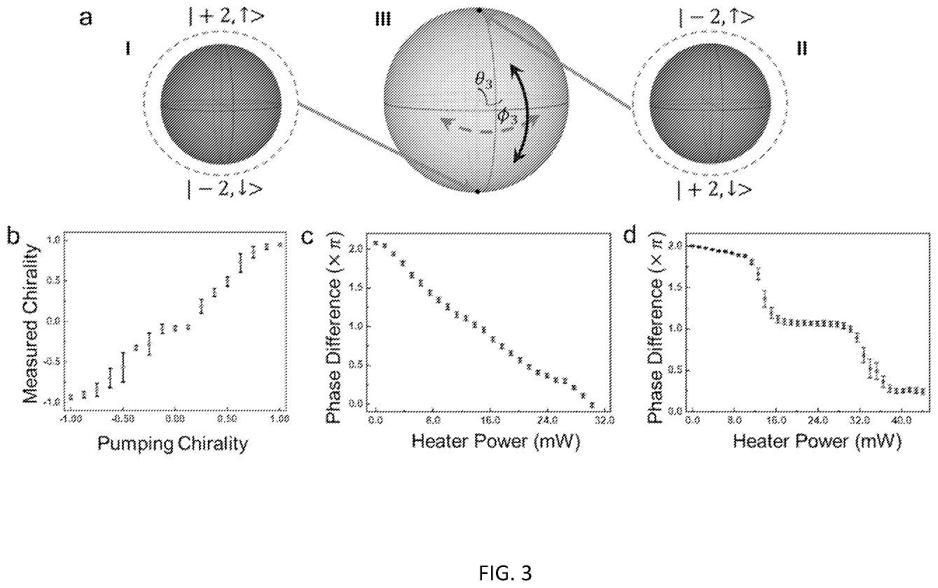

FIG. 12 depicts a comparison of analytical results and experimental data in FIG. 3c for phase tuning on HOPS III. (a) & (b), Phase ϕ and wavelength as a function of the detuning. The experimental data (dashed) is scaled on the horizontal axis by the same amount in these two figures. k is the effective coupling between the two rings in the Hamiltonian H. (c), Imaginary parts of the four eigenvalues of H′, which are dimensionless and represent the lasing thresholds. The dash-dotted lines show the other three modes that are not lasing (i.e., ∈′_{1,2,3}). Parameters used are:

$$η = 6.77 \times 1 {0}^{- 5} , \frac{{g}_{i}}{k} = 2.30 \times 1 {0}^{- 5} , max ( \frac{{g}_{r}}{k} ) = 3 \times 1 {0}^{- 4} .$$

The latitudes in the two rings are θ=0.11π and 0.70π, respectively.

FIG. 13 depicts a comparison of analytical results and experimental data in FIG. 3d for phase tuning on HOPS III. Parameters used are: The initial η=(3.3+1.3i)×10⁻⁵, and its phase changes by 2π linearly;

$$max ( \frac{{g}_{r}}{k} ) = 1.5 \times 1 {0}^{- 4} .$$

The latitudes in the two rings are θ=0.44π and 0.54π, respectively.

FIG. 14 depicts relative phase retrieval using Fourier analysis from the far-field emission of two rings. (a), Interference fringes |Gₗᵣ|² from two rings at the far-field. (b), Magnitude of the inverse Fourier transform of |Gₗᵣ|², with bandpass-filtering (square window) and shifting (arrow) marked. (c), Reconstructed far-field intensity |GₗGᵣ*|². (d), Retrieved relative phase ϕ between two rings.

FIG. 15 depicts scalability of the hyperdimensional spin-orbit microlaser. (a). The scheme of a 3-unit-cell microlaser array. The red box marks the unit cell of the scalable hyperdimensional spin-orbit microlaser array design which includes a microring resonator and two 3-dB directional couplers. (b). The scheme of a 4-unit-cell microlaser array. Each unit cell is cascaded with each other, forming a closed loop. (c). Numerical simulation of the structure shown in panel (a). The control waveguide 1 is pumped while control waveguide 2 is not pumped (g₁>>g₂). As predicted by the theory, numerical simulation result shows unidirectional CW powerflow. (d). Standing wave patterns are clearly observed when both control waveguides in the unit cell are equally pumped (g₁=g₂), where both CW and CCW modes coexist with the same amplitude. (e). CCW unidirectional mode is observed when only the control waveguide 2 in the unit cell is pumped (g₂>>g₁). (f) & (g). Phase control between CW and CCW modes in a unit cell: (f) shows the interference patterns with the heater off (φ₁=φ₂). White dashed line is aligned with the constructive interference lobe to help better visually distinguishing the phase difference; and (g) shows the simulated patterns with the heater control on (φ₁−φ₂=π). The white dashed line is now aligned with the destructive interference position, confirming the π phase difference between the two counter propagating modes.

### DETAILED DESCRIPTION OF ILLUSTRATIVE EMBODIMENTS

The present disclosure may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable, and it should be understood that steps may be performed in any order. Any documents cited herein are incorporated by reference in their entireties for any and all purposes.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. Further, reference to values stated in ranges include each and every value within that range. In addition, the term “comprising” should be understood as having its standard, open-ended meaning, but also as encompassing “consisting” as well. For example, a device that comprises Part A and Part B may include parts in addition to Part A and Part B, but may also be formed only from Part A and Part B.

A step toward the next generation of high-capacity, noise-resilient communication and computing technologies is a significant increase in the dimensionality of information space and the synthesis of superposition states on an N-dimensional (N>2) Hilbert space featuring exotic group symmetries. Despite the rapid development of photonic devices and systems, on-chip information technologies are mostly limited to two-level systems due to the lack of sufficient reconfigurability to satisfy the stringent requirement for 2(N−1) degrees of freedom, intrinsically associated with the increase of synthetic dimensionalities.

Even with extensive efforts dedicated to recently emerged vector lasers and micro-cavities for the expansion of dimensionalities, it still remains a challenge to actively tune the diversified, high-dimensional superposition states of light on demand.

An aspect of the disclosure provides a hyperdimensional, spin-orbit microlaser for chip-scale flexible generation and manipulation of arbitrary four-level states. Two microcavities coupled through a non-Hermitian synthetic gauge field are designed to emit spin-orbit-coupled states of light with six degrees of freedom (DOF). The vectorial state of the emitted laser beam in free space can be mapped on a Bloch hypersphere defining an SU(4) symmetry, demonstrating dynamical generation and reconfiguration of high-dimensional superposition states with high fidelity.

Information systems today are built upon binary digits (i.e., bits), taking two possible values: 0 or 1. When dealing with a quantum bit or its classical analogue, any arbitrary coherent superposition of them is allowed. Such binary representations can be equivalently translated to a two-level system, where the dynamical evolution and manipulation of the state are conveniently described on a Bloch (or Poincaré) sphere using the SU(2) algebra. With the continuously growing demand for increased information density and security, there is a necessity for constructing and exploring a larger Hilbert space towards a generic N-level system, realizing effective control on a higher-dimensional Bloch hypersphere (an extension of a Bloch sphere for an arbitrary N-level system). For example, the SU(4) group represents unitary operations in a four-level system where four eigen bases form a four-dimensional (4D) Hilbert space. An arbitrary state in it is the superposition of these eigen bases with four complex coefficients, and the increased dimensionality enables superdense coding, signal fidelity, and accelerated computation with reduced complexity and increased algorithm efficiency. Although similar mathematical frameworks are being formulated for the SU(N) symmetry, their experimental demonstration has not been realized to date in contrast to the two-level system, especially for free space, long-haul communications. One major challenge is to gain full control of the 2(N−1) DOFs required by a generic N-level pure state |Ψ [symbol] .

Optical beams carrying spin angular momentum provide an important class of two-level systems, which can be represented on a standard Bloch sphere. Here, the two pole states correspond to orthogonal polarizations, while the rest of the sphere covers all other possible polarization states of light, with the unitary operators connecting them via the SU(2) group. Spatial modes, in addition to polarization, offer a promising route to high-dimensional Hilbert spaces with the mathematical framework generalized from the conventional spin Bloch sphere to the spin-orbit high-order Poincaré sphere (HOPS), by incorporating both spin(s) and orbital angular momenta (OAM: l) of light. The complex optical fields described by the HOPS are non-separable states (except at the poles) with respect to spin and OAM, and hence important in promoting scalar OAM beams to a more general type of spin-orbit vectorial states, enhancing the spectral efficiency for a high-capacity communication network. Although manipulating spin-orbit vectorial states of light can in principle generate a 4D Hilbert space and its SU(4) algebra, a single HOPS achieved so far is still limited to the SU(2) algebra as a subspace of a four-level system.

Described herein is a fully integrated semiconductor microlaser exploiting spin-orbit coupling of light to drastically expand the DOFs as compared to the state-of-the-art. Tunable asymmetric couplings enabled by a synthetic imaginary gauge field provide flexible control of up to six DOFs, thus enabling the full coverage of a 4D Hilbert space. Further described herein are demonstrations of versatile spin-orbit-coupled beam emission control, precise generation and arbitrary reconfiguration of high-dimensional superposition states, and characterizations of the vectorial coherence of laser emission mapped on the Bloch hypersphere defined by the SU(4) algebra.

### Design

The hyperdimensional microlaser, emitting in a 4D Hilbert space, can include two same-sized microrings fabricated on a III-V semiconductor platform with 200 nm thick InGaAsP multiple quantum wells. The microrings are coupled through an imaginary gauge formed by four control waveguides, which are themselves connected using two 3-dB directional couplers (FIG. 1a and FIG. 1b). Each microring intrinsically supports two degenerate modes (clockwise (CW) and counterclockwise (CCW)) at a target frequency. Therefore, it effectively features an SU(2) group, and the entire laser can be viewed as a four-level system described by the following Hamiltonian:

$$H = [ \begin{matrix}{ω}_{cw , II} + {ig}_{i} + {g}_{r} & 0 & - {ike}^{{g}_{1} {g}_{3} + i ( {φ}_{1} + {φ}_{3} )} & - {ke}^{{g}_{2} + {g}_{3} + i ( {φ}_{2} + {φ}_{3} )} \\ 0 & {ω}_{ccw , II} + {ig}_{i} + {g}_{r} & {ke}^{{g}_{1} + {g}_{4} + i ( {φ}_{1} + {φ}_{4} )} & - {ike}^{{g}_{2} + {g}_{4} + i ( {φ}_{2} + {φ}_{4} )} \\ - {ike}^{{g}_{2} + {g}_{4} + i ( {φ}_{2} + {φ}_{4} )} & - {ke}^{{g}_{2} + {g}_{3} + i ( {φ}_{2} + {φ}_{3} )} & {ω}_{cw , I} - {ig}_{i} - {g}_{r} & 0 \\ {ke}^{{g}_{1} + {g}_{4} + i ( {φ}_{1} + {φ}_{4} )} & - {ike}^{{g}_{1} + {g}_{3} + i ( {φ}_{1} + {φ}_{3} )} & 0 & {ω}_{ccw , I} - {ig}_{i} - {g}_{r}\end{matrix} ]$$

Here, ω_{cw,I}, ω_{ccw,I}, ω_{cw,II}, and ω_{ccw,II} are the resonant frequencies of four degenerate modes in the two microring resonators, with the subscripts denoting their chirality (CW and CCW) and location (I, left, and II, right); gᵣ and igᵢ denote the real frequency detuning and the gain-loss contrast between the two microring resonators, respectively; k represents the effective coupling strength between the two microrings; g₁₋₄ corresponds to the single pass amplification/attenuation through control waveguides 1-4, respectively, while φ₁₋₄ is the accumulated phase when light propagates through each control waveguide. Although the CW and CCW modes in the same microring do not couple with each other directly, they interact through both modes in the other microring resonator. The fundamental eigenmode of the microlaser can be described as |Ψ [symbol] =[E_{II} rE_{I}]^{T}, where

$${E}_{I} = {[ \begin{matrix}{E}_{cw , I} & {E}_{ccw , I}\end{matrix} ]}^{T} = {[ \begin{matrix}- {ie}^{- \frac{{g}_{1} - {g}_{2}}{2} - i \frac{{φ}_{1} - {φ}_{2}}{2}} & {e}^{\frac{{g}_{1} - {g}_{2}}{2} + i \frac{{φ}_{1} - {φ}_{2}}{2}}\end{matrix} ]}^{T} \\ and$$

$${E}_{II} = {[ \begin{matrix}{E}_{cw , II} & {E}_{ccw , II}\end{matrix} ]}^{T} = {[ \begin{matrix}- {ie}^{\frac{{g}_{3} - {g}_{4}}{2} + i \frac{{φ}_{3} - {φ}_{4}}{2}} & {e}^{\frac{{g}_{3} - {g}_{4}}{2} - i \frac{{φ}_{3} - {φ}_{4}}{2}}\end{matrix} ]}^{T}$$

are the eigenvectors in the left and right microrings, respectively, where

$$r = \frac{\sqrt{{g}^{′2} + {η}^{2}} + {g}^{′}}{η}$$

with g′=(gᵢ−igᵣ)/2k and η=eΣ^{j(gj+iφj)/2}. It is therefore evident that selective pumping and phase tuning of the control waveguides quantify four DOFs necessary for individual control of two SU(2) groups: g₁−g₂ and φ₁−φ₂ for the control of the chirality and phase in the left ring, whereas g₃−g₄ and φ₃−φ₄ for the right ring. Additionally, the amplitude and phase of r, which can be controlled, for example, by gᵣ and gᵢ, provide two additional DOFs to realize a full 4D Hilbert space.

To elucidate the SU(4) property of this microlaser, three HOPSs are introduced with a total of six DOFs. Each HOPS features a north pole state |N [symbol] and a south pole state |S [symbol] , and their amplitude ratio and relative phase are represented by the latitude θ and longitude ϕ on the HOPS, respectively:

$$\vert Ψ ( θ , ϕ ) 〉 = cos ( θ / 2 ) {e}^{- i ϕ / 2} \vert N 〉 + sin ( θ / 2 ) {e}^{i ϕ / 2} \vert S 〉 .$$

Below, HOPS I is used to depict the left ring with |N_{I} [symbol] =|+2, ↑) and |S_{I} [symbol] =|−2, ↓), whereas HOPS II represents the right ring with |N_{II} [symbol] =|−2, ↑) and |S_{II} [symbol] =|+2, ↑). The microring cavities can be designed to generate the desired pole states and enable the spin-orbit locking: |N_{I} [symbol] and |S_{I} [symbol] are translated from CW and CCW modes of left ring, and so do |N_{II} [symbol] and |S_{II} [symbol] for the right ring. Note that these four spin-orbit-coupled states overlap completely in both space and time and share the same diffraction and modal conversion (from free space to fibers and vice versa), so these states can maintain their coherence after long-distance propagation, which is critical for long-haul communications. The SU(4) hypersphere is completed by HOPS III. Its north (south) pole state can be arbitrarily chosen on HOPS II (I)(FIG. 1a). Note that the coupling of HOPS I and II on HOPS III, while each representing a distinct SU(2) group, enables the generation of the high-dimensional superposition states that cover the entire 4D Hilbert space. With the full control over the six DOFs discussed above, the tuning operations involved contain a representation of the SU(4) group.

### Manipulation on SU(4) Bloch Hypersphere

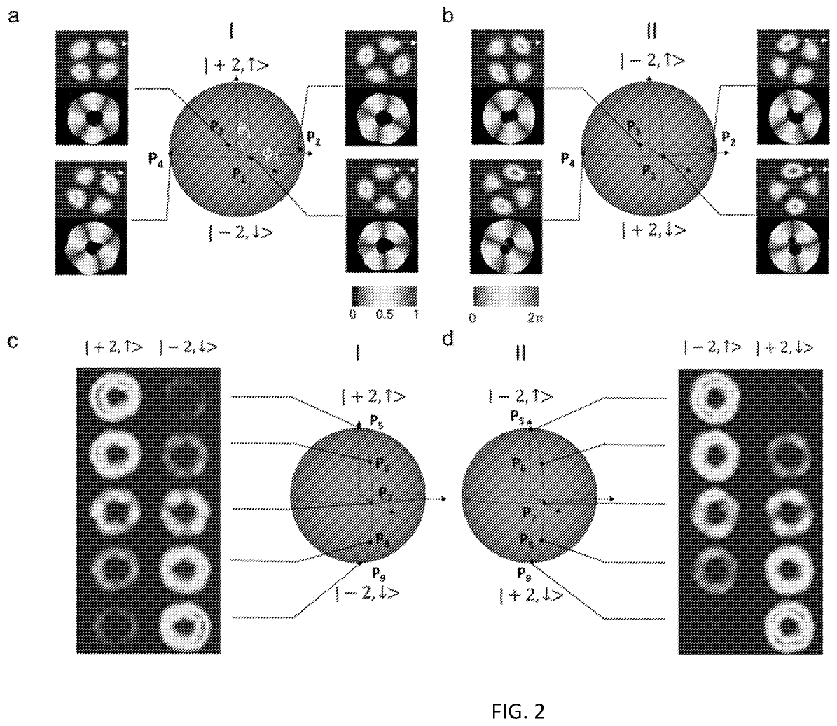

One prominent feature of our system is that these three HOPSs can be independently controlled. Here, HOPS I and II are focused on. In the lasing mode, g₁−g₂ and φ₁−φ₂ determine the latitude and longitude on HOPS I, and so do g₃−g₄ and φ₃−φ₄ on HOPS II. These two HOPSs can be selectively characterized while the entire microlaser is pumped (including the control waveguides to maintain the non-Hermitian-controlled gauge): the emission from one of them is collected and analyzed, one at a time. The gain and phase accumulation in each control waveguide can be individually tuned by selective optical pumping, using a nanosecond laser, and heating, using a continuous-wave laser, both at the wavelength of 1064 nm (see Methods). For example, by applying equal optical pumping of the nanosecond laser to waveguides 1 and 2 (i.e., g₁=g₂), the spin-orbit state of laser emission from the left microring contains equally weighted |N_{I} [symbol] and |S_{I} [symbol] and is thus confined along the equator of HOPS I. To manipulate the state in the azimuthal direction, heating pads 1 and 2 (FIG. 1a) are selectively excited, where the local temperature increase mainly induces the phase accumulation in their adjacent waveguides (i.e., φ₁ and φ₂, respectively). By varying the heating powers on the two heating pads, the relative phase φ₂−φ₁ can be swept from 0 to 2π, enabling the full phase control along the longitude of HOPS I (FIG. 2a). Non-separability intrinsically associated with spin-orbit-coupled vectorial states is validated by placing a horizontally polarized linear polarizer in the optical path. The intensity patterns collected after the linear polarizer show 4 lobes in the azimuthal direction, resulting from the interference of equally weighted OAM orders of ±2; these patterns rotate as a function of (φ₂−φ₁)/4, and the relative phase between the two OAM orders manifests an 8π winding measured using Stokes polarimetry. Similar phase control can be independently carried out on HOPS II in the right microring (FIG. 2b), using heaters 3 and 4 to maneuver φ₃−φ₄ in waveguides 3 and 4. The orientation of the 4 lobes rotates in the opposite azimuthal direction because now the north pole state has l=−2 instead of l=2.

To reconfigure the state along the latitude of HOPS I and II, selective pumping of the nanosecond laser is projected onto the control waveguides to tune their amplification/attenuation rates (e.g., g₁−g₂ for the left microring), and thus, the power ratio between two pole states, as suggested by the definition of θ. Five special states are produced along the latitude at ϕ=0 on HOPS I with an equal spacing of π/2(P₅₋₉ in FIG. 2c), where the intensities of the two spin components reveal the evolution of the ratio between |N_{I} [symbol] =|+2, ↑> and |S_{I} [symbol] =|−2, ↓>, corresponding to the evolution of the resonant mode in the left microring from purely CCW to purely CW. Similar chiral control can be independently performed in the right microring, by manipulating the state along the latitude of HOPS II from |N_{II} [symbol] =|−2, ↑> to |S_{II} [symbol] =|+2, ↓> (FIG. 2d).

To complete the state control on the SU(4) Bloch hypersphere, the maneuver on HOPS III are detailed, arising from the superposition of vectorial states on HOPS I and II (FIG. 3a): As aforementioned, their relative amplitude and phase between two vector beams can be controlled inherently via gᵢ and gᵣ in Eq. (1), which do not affect HOPS I and II. The gain/loss contrast gᵢ between the two microrings can be precisely controlled by projecting different pump powers onto them. Its dominant effect is tuning the latitude on HOPS III, as can be seen from the continuous variation of emission power chirality from two rings (FIG. 3b). Phase tuning on HOPS III is accomplished with the onsite frequency detuning between two microrings (e.g., gᵣ), by selectively heating pad 5 or 6 (FIG. 1) to create a temperature gradient in the horizontal direction across the microlaser. Although this procedure may also alter the refractive index of the control waveguides, and in turn, the phase accumulation in each waveguide (i.e., φᵢ), φ₂−φ₁ and φ₃−φ₄ remain unchanged due to the placements of these two heating pads. Therefore, HOPS I and II are not affected when the states on HOPS III are moved. To demonstrate phase control between two microrings, two experiments under different settings are conducted. In both cases, heating pad 5 is pumped using the continuous-wave laser with precisely controlled power, and states at ϕ=0 on both HOPS I and II are chosen. The phase difference between two microrings is extracted by analyzing the far field emission patterns. In the first case, the left microring is dominated by the CCW mode (θ≈0.11π on HOPS I), while both CW and CCW modes exist in the right microring (θ≈0.70π on HOPS II). The phase difference versus heating laser power is plotted in FIG. 3c, showing nearly linear phase tuning in a full 2π range. In the second case, CW and CCW modes coexist in both microrings (θ≈0.44π and 0.54π on HOPS I and II, respectively), and π phase jumps are observed in experiments, as shown in FIG. 3d, which could be explained by supermode-hopping during the power heating scan. Note that compared with theoretical predictions, the experimental system revealed richer dynamics so a wider tuning range of the longitude on HOPS III was observed in experiments.

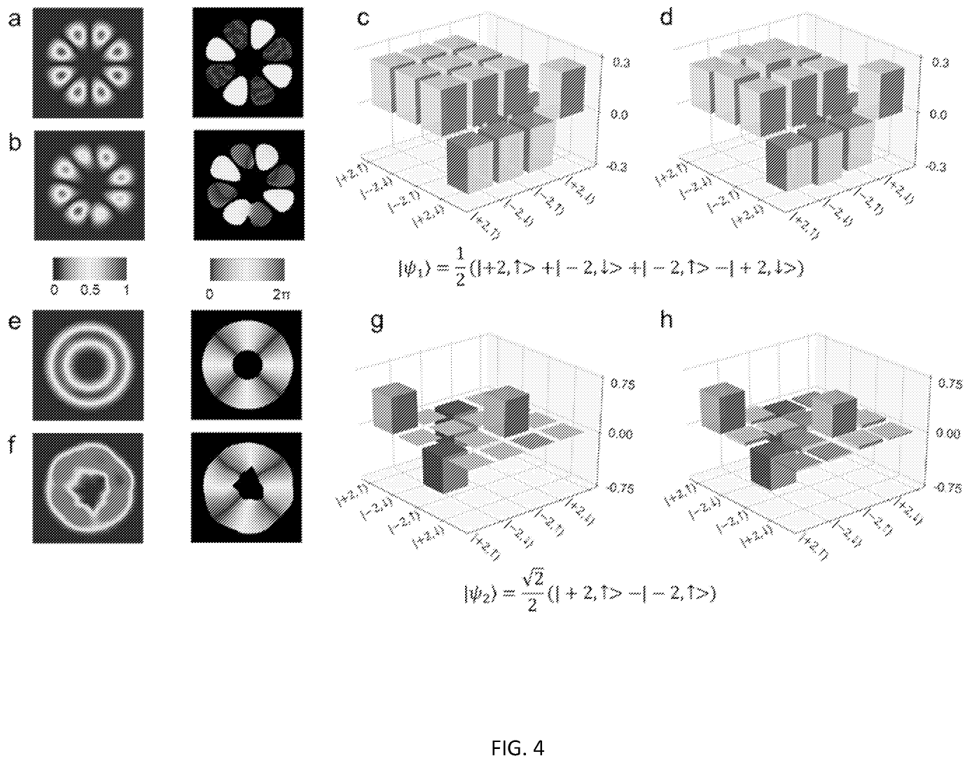

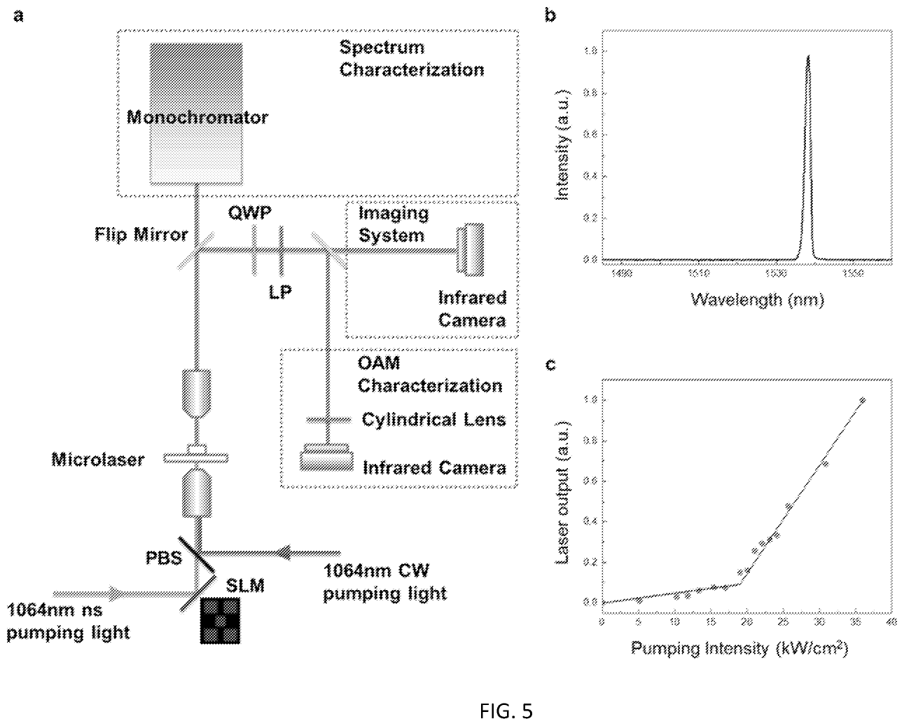

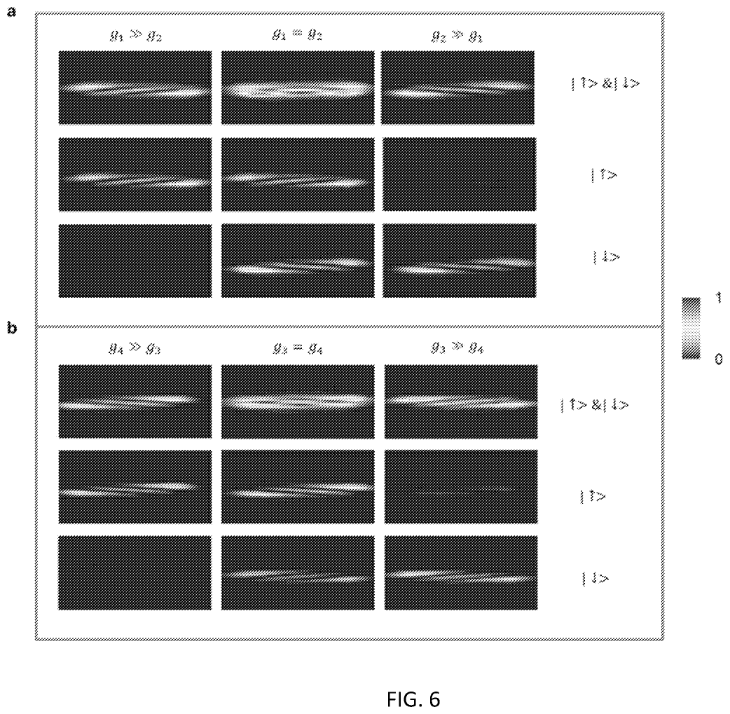

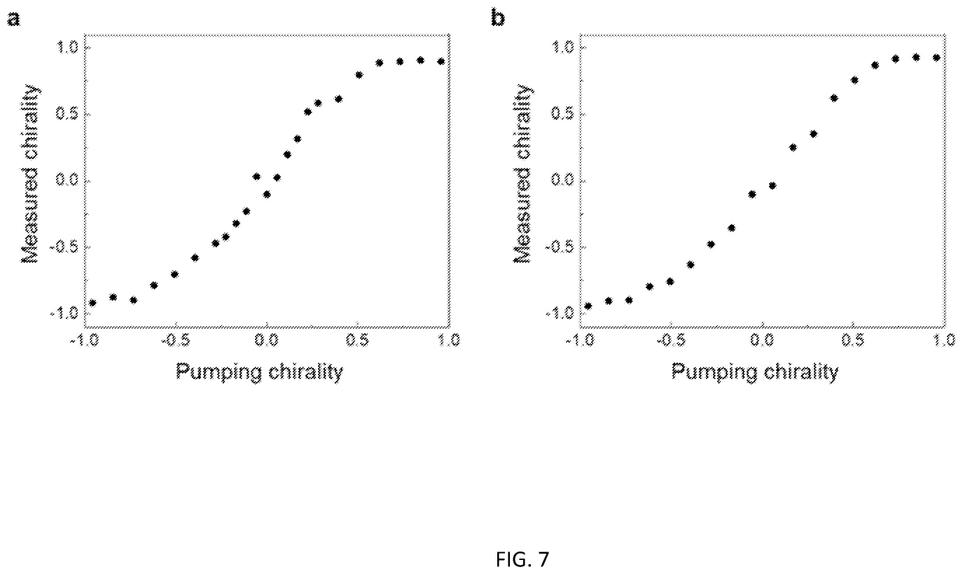

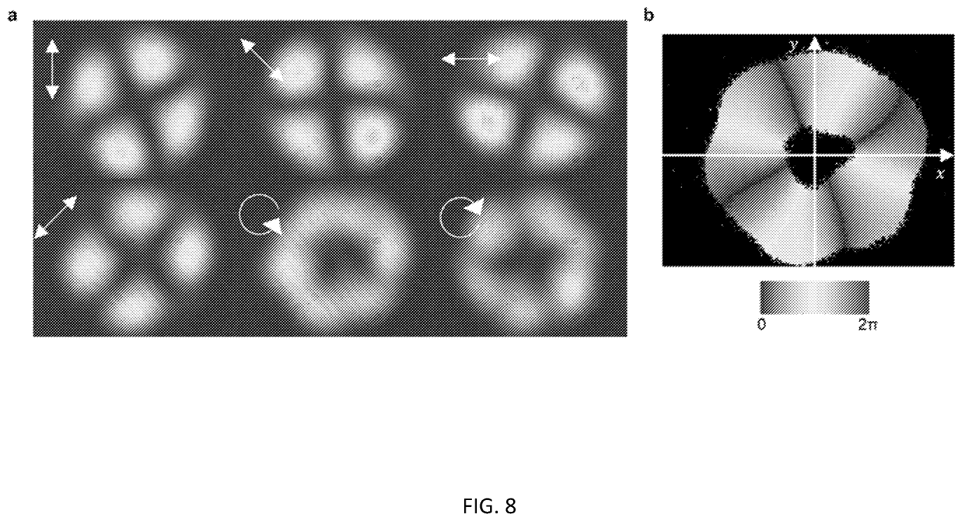

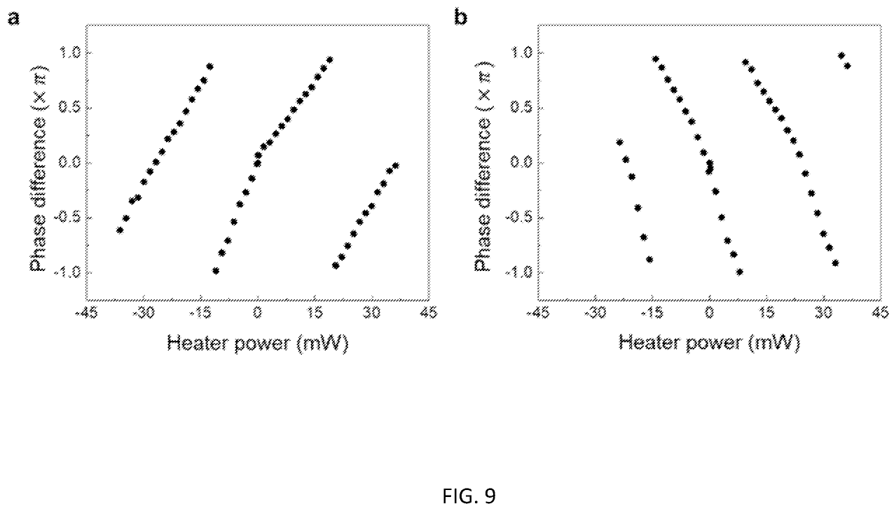

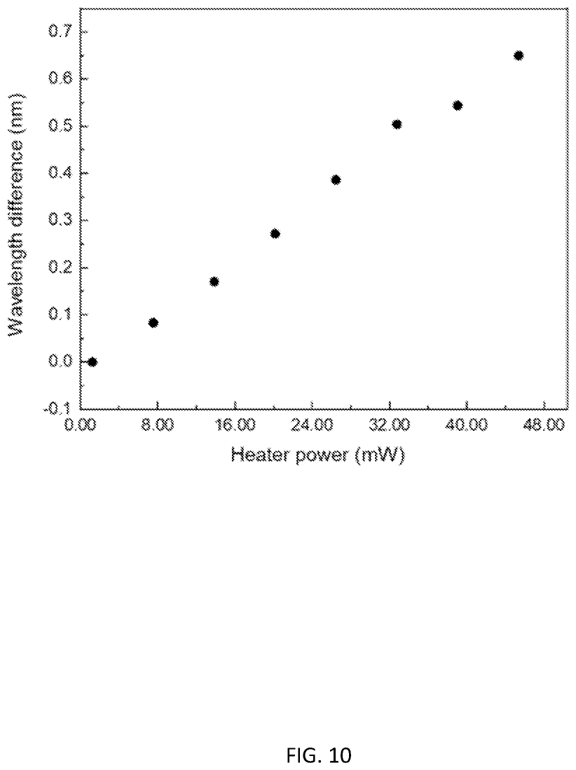

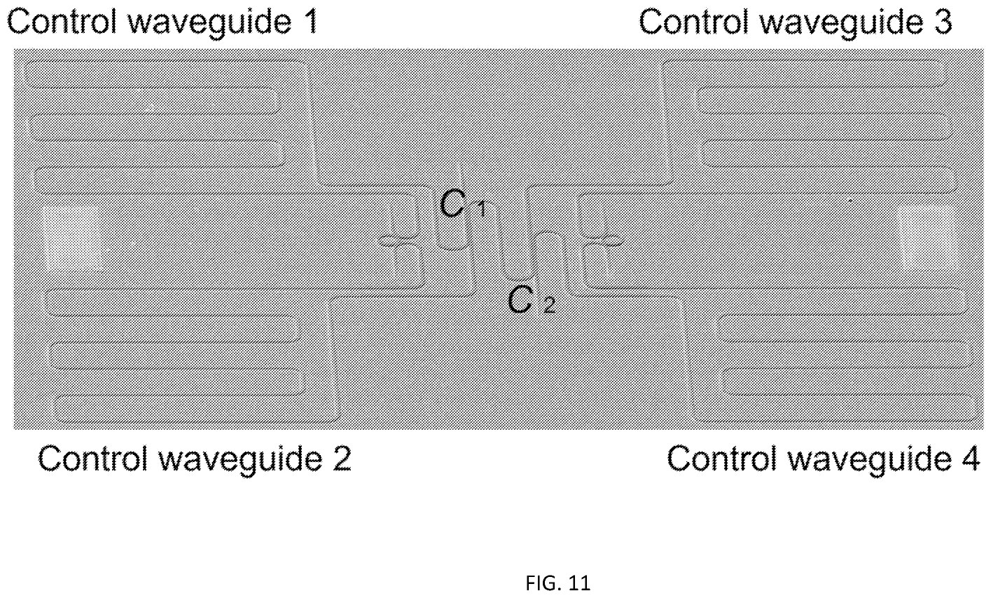

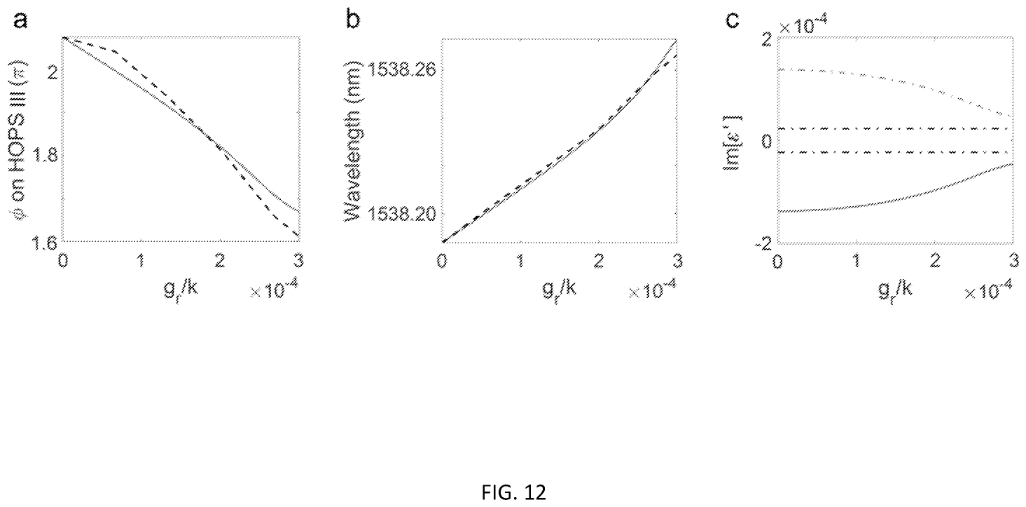

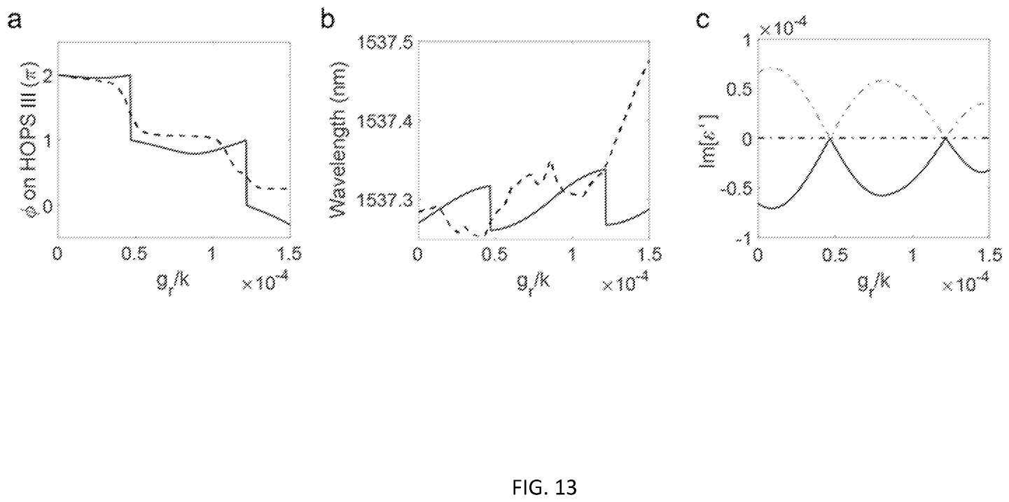

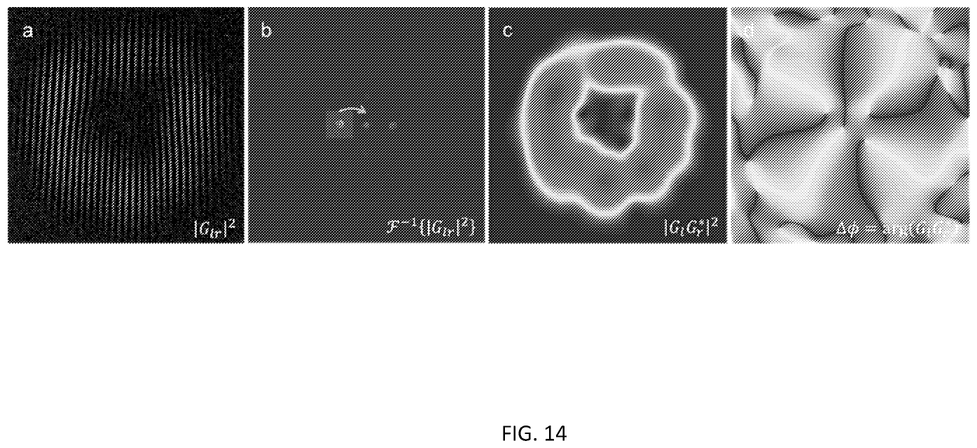

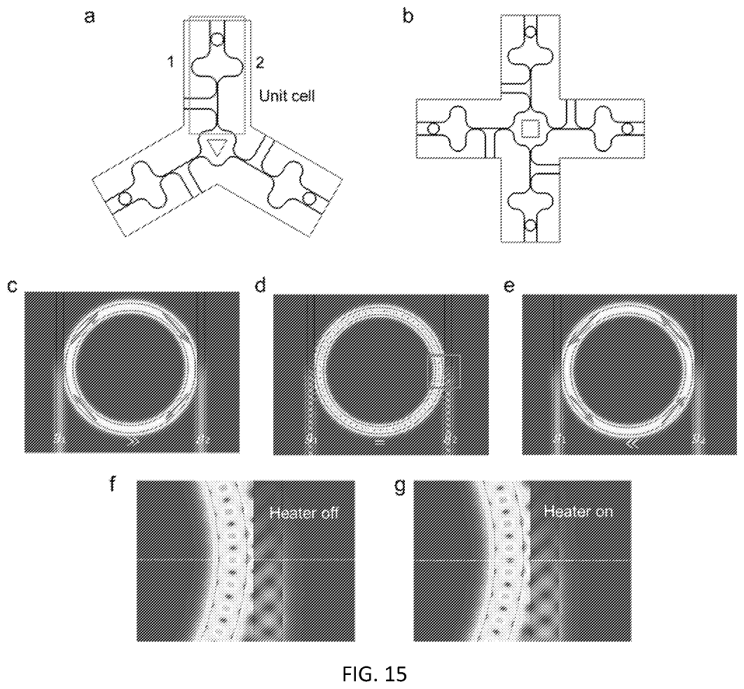

The ability to map the vectorial states on the SU(4) Bloch hypersphere enables the generation and reconfiguration of intriguing higher-dimensional states that are resilient to noise, and therefore, important in computations and communications for error corrections. FIG. 4 demonstrates the generation and reconfiguration between two iconic states using the described hyperdimensional microlaser:

$$\vert {ψ}_{1} 〉 = \frac{1}{2} ( \vert + 2 , ↑ 〉 + \vert - 2 , ↓ 〉 + \vert - 2 , ↑ 〉 - \vert + 2 , ↓ 〉 ) ,$$

a spin-orbit high-dimensional superposition state corresponding to the in-phase superposition of state P1 on HOPS I (FIG. 2a) and state P3 on HOPS II (FIG. 2B); and

$$\vert {ψ}_{2} 〉 = \frac{\sqrt{2}}{2} ( \vert + 2 , ↑ 〉 - \vert - 2 , ↑ 〉 ) ,$$

a non-vectorial state representing the out-of-phase superposition of P5 on HOPS I (FIGS. 2c) and P5 on HOPS II (FIG. 2d). In the far field, while the two vector beams overlap perfectly in size and geometry, interference fringes arise as a result of their slightly different emission angles, which experimentally facilitates the retrieval and analysis of only the cross-correlated term. This property allows confirmation of spatially inhomogeneous and vectorial characteristics of the superposition state: For state |ψ₁ [symbol] , opposite polarization windings from the two rings (see the phase winding maps in FIGS. 2a and 2b) yield a cross-correlation pattern with 8 lobes in the far field with their phase alternatingly quantized at either 0 or π (FIGS. 4a and 4b), where high/low intensity denotes aligned/orthogonal polarizations, respectively. Furthermore, the experimentally measured density matrix shows high fidelity of 0.998, consistent with the calculated result (FIG. 4c and FIG. 4d). Dynamical reconfiguration of selective pumping can swiftly transform laser emission from |ψ₁ [symbol] to |ψ₂ [symbol] . The two eigen-states in |ψ₂ [symbol] possess the same polarization, therefore leading to a cross-correlation pattern with uniform intensity in the far field and a continuous phase winding of 8π in the azimuthal direction (FIGS. 4e and 4f). The phase winding arises from the phase difference associated with opposite OAM orders of ±2. The experimentally retrieved density matrix also agrees well with theoretical calculations, showing high fidelity of 0.942 (FIGS. 4g and 4h).

Demonstrated herein, as an aspect of the disclosure, is a non-Hermitian-controlled spin-orbit microlaser, whose emitted beams are intrinsically spatially inhomogeneous and possess six DOFs, allowing for the arbitrary generation and dynamical reconfiguration of intriguing high-dimensional superposition states with high fidelity. While being classical, such high-dimensional superposition states, when attenuated to the single photon level, can be applied to perform well-established decoy state protocols for high-dimensional quantum key distribution with a higher security key rate. Additionally, intrinsic spin-orbit non-separability associated with the high-dimensional superposition state features high-dimensional non-separable states with the potential to further promote the precision limit in metrology, imaging, and information science. The carefully selected four spin-orbit-coupled states can possess the same propagation properties and completely overlap in both space and time, thereby maintaining long-distance coherence that is ideal for free space quantum communication. The hyperdimensional microlaser provides an integrated solution for the deployment of next generation high-capacity, noise-resilient communication technologies.

### Design of the Microring Cavity for Spin-Orbit Emission

The geometry of the cross-section of the microring resonator (e.g., 600 nm wide and 200 nm thick) is designed to enable spin-orbit locking: left-hand (↑: spin-up with s=+1) or right-hand (↓: spin-down with s=−1) polarization in the evanescent tail of guided mode is locked to only one chiral mode (either CW or CCW). The diameter of the microrings can be, e.g., 7 μm, thereby supporting a whispering gallery mode with azimuthal order N=33 at the lasing wavelength of approximately 1538 nm. Two sets of angular gratings with different orders M=30/34 are inscribed on the inner sidewall of the left and right microrings (FIG. 1c), respectively, leading to the total angular momentum for extracted laser emission: J=l+s=C(N−M)=±3/±1, where C=±1 for CCW and CW modes, respectively. In other words, the spin-orbit locked states |l, s [symbol] in the left ring are |+2, ↑ [symbol] (CW) and |−2, ↓ [symbol] (CCW), whereas those in the right ring are |−2, ↑ [symbol] (CW) and |+2, ↓ [symbol] (CCW). The OAMs of the four eigen states are designed to carry the same topological charge (i.e., ±2) to ensure their perfect spatial overlap in the far-field. As a result, a 4D Hilbert space and its associated SU(4) Bloch hypersphere are formed by arbitrary coherent superpositions of the laser emission from these two microrings in free space.

### Sample Fabrication

The device was fabricated using standard nanofabrication techniques based on electron beam lithography. Hydrogen silsesquioxane (HSQ) solution in methyl isobutyl ketone (MIBK) was used as a negative electron beam lithography resist. The concentration ratio of HSQ (FOX15) and MIBK was adjusted such that after exposure and development the resist was sufficiently thick as an etching mask for subsequent dry etching. The resist was then soft-baked, and the structure was patterned by electron beam exposure. Electrons convert the HSQ resist to an amorphous oxide. The patterned wafer was then immersed and slightly stirred in the tetramethylammonium hydroxide (TMAH) solution (MFCD-26) for 120 seconds and rinsed in de-ionized water for 60 seconds. The exposed and developed HSQ pattern served as a mask for the subsequent inductively coupled plasma etching process that uses BCl₃: Ar plasma with a gas ratio of 15:5 sccm, respectively, with RF power of 50 W and ICP power of 300 W under a chamber pressure of 5 mT. After dry etching, HSQ resist was removed by immersing the sample in buffered oxide etchant (BOE). To overcome potential ring-to-ring non-uniformity at the nanoscale across the whole device due to fabrication imperfection, the sample was covered with a cladding layer of Si₃N₄ using plasma enhanced chemical vapor deposition to enhance the evanescent coupling strengths to ensure relatively high coupling despite slight frequency detuning. The wafer was then bonded to a glass slide which functions as a holder. Finally, the InP substrate was removed by wet etching with a mixture of HCl (Hydrochloride acid) and H₃PO₄ (Phosphoric acid).

### Experimental Setup and Characterizations of the Lasing Spectrum and OAM Order

The fabricated sample is characterized using the optical setup shown in FIG. 5a with respect to its lasing wavelength, OAM, and the control on HOPS. The microlaser is pumped from the backside by a nanosecond pulsed laser with a 10 kHz repetition rate and 8 ns duration at a wavelength of 1064 nm. The pulsed pumping light is shaped by a spatial light modulator and imaged onto the sample through a 4-f demagnification system and its intensity is controlled by using a combination of a half waveplate and a polarization beam splitter. A continuous wave laser at 1064 nm for heating is focused onto the sample by the same 10× microscope objective with a numerical aperture (NA) of 0.28 used in the 4-f demagnification system. Its power is directly controlled by its pumping current. The laser emission from the front side was collected by a 20× microscope objective (NA=0.42) and guided into a monochromator for the spectral analysis. The beam was passed through a spatial filter on demand for beam selection (e.g., a pinhole at the imagine plane to observe the emission from either the left ring, the right ring, or both) and later passed through a linear polarizer with 0, 45, 90 and 135 degrees to the vertical direction and a combination of a linear polarizer and quarter wave plate into an imaging system to conduct the Stokes polarimetry (see Methods Section: Stokes polarimetry: Relative phase measurement). Additionally, a cylindrical lens is used to characterize the OAM nature of the emission. FIGS. 5b and c shows the measured lasing spectrum from the microlaser (FIG. 5b) and the light-light curve where the kink corresponds to the onset of laser action (i.e., laser threshold) (FIG. 5c).

The OAM nature of emissions from the spin-orbit microlaser is verified by using a cylindrical lens which performs a 1D Fourier transform of the input beam. The value of OAM charge can be determined by counting the number of dark lines in the measured patterns through the cylindrical lens while the sign of the OAM charge corresponds to the direction of the dark lines. The results confirmed the chiral control via selective pumping of the nanosecond laser (FIG. 6).

FIG. 6a shows laser emission from the left microring and its chiral control on HOPS I. In the scenario where all the control waveguides except waveguide 2 are pumped, reaching the condition of g₁>>g₂, which leads to the excitation of only state |N_{I} [symbol] =|+2, ↑> on HOPS I. The captured image (unpolarized) shows fringe patterns with two dark lines pointing to the top right corner, confirming the OAM charge of emission to be +2. The polarization state of emission can be verified by using a combo of a quarter waveplate and a linear polarizer, showing only the left-handed circular polarization (i.e., spin-up: ↑). If all the control waveguides are equally pumped (i.e., g₁=g₂), laser emission becomes a superposition of |N_{I} [symbol] =|+2, ↑> and |S_{I} [symbol] =|−2, ↓>, moving to the equator on HOPS I. Without the selection of polarizations, there is no clear dark line, indicating no net OAM. However, if we selectively extract only the left circular polarization component (e.g., spin-up: ↑), the fringe pattern shows two dark lines pointing to the top right corner, suggesting the OAM charge to be +2; on the other hand, if only the right circular polarization (e.g., spin-down: ↓) component is selected, the fringe pattern shows two dark lines pointing to the top left corner, manifesting the OAM charge to be −2. If only waveguide 1 is selectively unpumped, the condition of g₂>>g₁, is reached, which yields the excitation of only state |S_{I} [symbol] =|−2, ↓>on HOPS I. Consequently, the unpolarized image is the consistent with the spin-down image, showing the intrinsic right-hand circular polarization of emission. The fringe pattern also shows two dark lines pointing to the top left corner, validating the OAM charge of −2.

Similarly, FIG. 6b shows laser emission from the right microring and its chiral control on HOPS II. If all the control waveguides except waveguide 3 are pumped, the condition is g₄>>g₃, corresponding to the excitation of only state |N_{II} [symbol] =|−2, ↑> on HOPS II. In this case, the fringe pattern shows two dark lines pointing to the top left corner and contains only the spin-up component. At the condition of g₃=g₄ when all the waveguides are equally pumped, the unpolarized image shows zero net OAM with its spin up component corresponding to |N_{II} [symbol] =|−2, ↑> and its spin-down component being |S_{II} [symbol] =|+2, ↓>, as suggested by the opposite orientations of the two dark lines in the fringe patterns. If g₃>>g₄, we observe only the spin-down component with the OAM charge of +2, verifying the successful excitation of only |S_{II} [symbol] =|+2, ↓>.

Moreover, the chirality of emission on each HOPS (e.g., the latitude of the HOPS) can be systematically controlled by pumping different control waveguides with different power. Here, the pumping chirality can be defined as (P₁−P₂)/(P₁+P₂) for HOPS I and (P₄−P₃)/(P₄+P₃) for HOPS II, where Pᵢ is the pumping power applied on control waveguide i. The chirality of the emission can be defined as C=(I_{↑}−I_{↓})/(I_{↑}+I_{↓}), where intensity of each component can be conveniently measured by polarization filtering to select only the right spin. The experimentally measured chirality control of both microrings can be seen in FIG. 7. Note that three different conditions on each ring as shown in FIG. 6 correspond to emission chirality of +1, 0, and −1.

### Stokes Polarimetry: Relative Phase Measurement

Each individual HOPS represents the superposition of two spin-orbit-coupled states, where the latitude corresponds to the chirality between the two states, while the longitude is related to the relative phase between them. Since the two spin-orbit-coupled states carry opposite spins, their relative phase ϕ(x, y) at an arbitrary point on a HOPS can be retrieved using the Stokes polarimetry: ϕ(x, y)=atan 2(S₂, S₁)+π, where S₁=I₀(x, y)−I₉₀(x, y) and S₂=I₄₅(x, y)−I₁₃₅(x, y), and as I₀(x, y), I₄₅(x, y), I₉₀(x, y), I₁₃₅(x, y) are intensities of linear polarization states at 0°, 45°, 90°, 135°. For example, FIG. 8 shows the intensity distribution of six difference polarization states of emission from the left microring at P2 on HOPS I (FIG. 6a), including 4 linear polarization states of 0°, 45°, 90°, 135° and 2 circular polarization states of spin ↑ and ↓.

Similar to the chiral control shown in FIG. 7, selectively exciting heaters 1-4 using the continuous-wave laser can introduce an active phase tuning scheme to move the state in the latitude of the HOPS. FIG. 9 shows the experimental demonstration of the control of the phase in the two individual HOPS (I and II) as a function of power difference of the laser beam applied on two pairs of heaters 1/2 and 3/4, respectively.

### Frequency Detuning Between Two Microring Lasers

Frequency detuning gᵣ and gain/loss contrast gᵢ between two microring lasers provide two extra knobs to control the 4D state in the Bloch hypersphere. Although gᵢ can be performed by controlling the power difference between nanosecond laser applied on the two microrings, gᵣ is conducted by exciting either heating pad 5 or 6. FIG. 10 shows the on-site frequency detuning between the two microrings as a function of the power of the continuous-wave laser applied on heating pad 5. In this experiment, only the two microrings are pumped by the nanosecond laser, while all four control waveguides are not. In this manner, the two microrings are uncoupled, so we can accurately measure their own resonant wavelengths from their respective lasing spectra and then determine the wavelength difference. Note that red shifts are observed for the resonant wavelengths of both microrings as the heating power increased, arising from the thermo-optical effect.

### Supplemental Information

The main results of our paper are the generation of arbitrary SU(4) superposition states in the 4D Hilbert space spanned by |+2, ↑ [symbol] , |−2, ↓ [symbol] , |−2, ↑ [symbol] , |+2, ↓ [symbol] . In the following we give the general definition of SU(N) state and explain some main concepts we used in our paper.

The construction of the SU(N) state in our paper follows the definitions given in Refs. 1 and 2. For the N×N matrix representation, the SU(N) state can be constructed by applying the elements in an SU(N) group on a reference state which is chosen to be |Y′o)= (1,0, . . . ,0)^{T} called the highest-weight state. The SU(N) group, by definition, is the Lie group of N×N unitary matrices with determinant 1. Its matrix representation has N²−1 elements. Starting with SU(2), it is typically represented by the 3 Pauli matrices in physics. Similarly, the SU(3) group can be represented by the 8 Gell-Mann matrices in the quark model. Gell-Mann's construction can be easily extended to SU(4), giving 15 traceless matrices. Note, however, this is just one convenient representation of the SU(4) group, just as the SU(2) group can be represented using another orthogonal basis other than the Pauli matrices. We first construct SU(2) states as an example. A general element g, in SU(2) group can be represented by:

$${g}_{2} = {R}_{z} ( ϕ ) {R}_{y} ( θ ) {R}_{z} ( ξ ) = {e}^{- i \frac{ϕ}{2} {σ}_{3}} {e}^{- i \frac{θ}{2} {σ}_{2}} {e}^{- i \frac{ξ}{2} {σ}_{3}} , \qquad ( S1 )$$

where σ₁, σ₂ and σ₃ are Pauli matrices:

$${σ}_{1} = ( \begin{matrix}0 & 1 \\ 1 & 0\end{matrix} ) , {σ}_{2} = ( \begin{matrix}0 & - i \\ i & 0\end{matrix} ) , {σ}_{3} = ( \begin{matrix}1 & 0 \\ 0 & - 1\end{matrix} ) . \qquad ( S2 )$$

By substituting Eq. (S2) into Eq. (S1), one can obtain the matrix form of g₂:

$${g}_{2} = ( \begin{matrix}{e}^{- i \frac{ϕ + ξ}{2}} cos \frac{θ}{2} & - {e}^{- i \frac{ϕ - ξ}{2}} sin \frac{θ}{2} \\ {e}^{i \frac{ϕ - ξ}{2}} sin \frac{θ}{2} & {e}^{i \frac{ϕ + ξ}{2}} cos \frac{θ}{2}\end{matrix} ) . \qquad ( S3 )$$

By applying this operator on |Ψ₀ [symbol] , the general form of SU(2) states can be written as:

$$\vert {N}_{2} 〉 = {e}^{- i \frac{ξ}{2}} [ \begin{matrix}{e}^{- i \frac{θ}{2}} cos \frac{θ}{2} \\ {e}^{i \frac{ϕ}{2}} sin \frac{θ}{2}\end{matrix} ] ( θ ∈ [ 0 , π ] , ϕ ∈ [ 0 , 2 π ] ) . \qquad ( S4 )$$

If we omit the trivial global phase, two degrees of freedom (DoFs) defined in mathematics (θ and ϕ) need to be controlled for the arbitrary generation of state |N₂ [symbol] . Such states can be represented by a point on the surface of a 3D sphere called a Bloch sphere (or a Poincare sphere in optics) which is widely used to depict an arbitrary two-level system, with θ and ϕ as the polar and azimuthal angles, respectively.

Similarly, SU(4) states |N₄ [symbol] can be generated by applying g₄∈SU(4) on |Ψ₀ [symbol] in a 4D Hilbert space, where g₄ is generated with 15 generators, and |N₄ [symbol] can be written as:

$$\vert {N}_{4} 〉 ∝ [ \begin{matrix}{e}^{- \frac{i {ϕ}_{3}}{2}} cos \frac{{θ}_{3}}{2} [ \begin{matrix}{e}^{- \frac{i {ϕ}_{2}}{2}} cos \frac{{θ}_{2}}{2} \\ {e}^{\frac{i {ϕ}_{2}}{2}} sin \frac{{θ}_{2}}{2}\end{matrix} ] \\ {e}^{\frac{i {ϕ}_{3}}{2}} sin \frac{{θ}_{3}}{2} [ \begin{matrix}{e}^{- \frac{i {ϕ}_{1}}{2}} cos \frac{{θ}_{1}}{2} \\ {e}^{\frac{i {ϕ}_{1}}{2}} sin \frac{{θ}_{1}}{2}\end{matrix} ]\end{matrix} ] ( {θ}_{1 , 2 , 3} ∈ [ 0 , π ] , {ϕ}_{1 , 2 , 3} ∈ [ 0 , 2 π ] ) , \qquad ( S5 )$$

where the global phase has been omitted. Here we have written them in such a way to emphasize that the subscripts 1,2,3 denote the three HOPSs, respectively. This should be straightforward to see by comparing it with the expression for an arbitrary state in a two-dimensional Hilbert space given above: θ₁ and ϕ₁ control the relative amplitude and phase between the two polar states |+2, ↑ [symbol] , |−2, ↓ [symbol] on HOPS I; θ₂ and ϕ₂ control the relative amplitude and phase between the two polar states |−2, ↑ [symbol] and |+2, ↓ [symbol] on HOPS II; and finally, θ₃ and ϕ₃ control the relative amplitude and phase between the two polar states

$$[ \begin{matrix}{e}_{i}^{- \frac{i {ϕ}_{1}}{2}} cos \frac{{θ}_{1}}{2} \\ {e}^{\frac{i {ϕ}_{1}}{2}} sin \frac{{θ}_{1}}{2}\end{matrix} ]$$

(from HOPS I) and

$$[ \begin{matrix}{e}^{- \frac{i {ϕ}_{2}}{2}} cos \frac{{θ}_{2}}{2} \\ {e}^{\frac{i {ϕ}_{2}}{2}} sin \frac{{θ}_{2}}{2}\end{matrix} ]$$

(from HOPS II) on HOPS III. As we have full control over these six DOFs (represented now by θ_{1,2,3} and ϕ_{1,2,3}), the tuning operations then must contain a representation of the SU(4) group as mentioned earlier.

From Eq. (S5) one can immediately tell that |N₄ [symbol] is equivalent to three coupled |N₂ [symbol] , so |N₄ [symbol] can be presented graphically on the surface of a high-dimensional sphere which we call a Bloch hypersphere (or a Poincare hypersphere) consisting of three coupled Bloch spheres (or high-order Poincare sphere (HOPS) used in our spin-orbit system) 5, i.e., HOPS I, HOPS II, and HOPS III, as shown in FIG. 3a.

Now, we can go back to our microlaser system. The 4D Hilbert space we discussed here is a four-level system spanned by 4 eigen bases: |+2, ↑ [symbol] , |−2, ↓ [symbol] , |−2, ↑ [symbol] , |+2, ↓ [symbol] , where ±2 and ↑↓ represent orbital angular momentum and spin, respectively. Therefore, states in this Hilbert space are called spin-orbit states. In this case, according to Eq. (S5), HOPS I and HOPS II describe the relative amplitude and phase between |+2, ↑ [symbol] , |−2, ↓ [symbol] and |−2, ↑), |+2, ↓ [symbol] , and HOPS III describes the relative amplitude and phase between HOPS II and HOPS I. By utilizing the gain/loss and phase control on waveguides and ring resonators, our microlaser can control all these 6 parameters and can coherently emit any |N₄ [symbol] state in a hyperdimensional Hilbert space, thereby covering the entire Bloch hypersphere. We thus called our microlaser a hyperdimensional spin-orbit microlaser.

If the state is not at the pole of the 3 HOPS, it cannot be factorized as a product of states belonging to spin and OAM, respectively. In this case, the state is in general non-separable with respect to spin and OAM and thus called a non-separable state in spin and OAM. For example, a vector beam on a single HOPS can be written as ψ=|s>|l [symbol] +|−s [symbol] |−l)(l≠0), which is non-separable in the spin and OAM since this state cannot be factorized as a product of spin and OAM. In contrast, if l=0, the state collapses as ψ=|s [symbol] |l [symbol] +|−s [symbol] |−l [symbol] =(|s)+|−s [symbol] )|l=0), which becomes a product of spin and OAM. In this special case, the state is viewed as a separable state. If considering two OAM and two spin states in their subspaces, the separable combination

$$\vert S 〉 ⊗ \vert L 〉 = ( {e}^{- \frac{i {ϕ}_{s}}{2}} cos \frac{{θ}_{s}}{2} \vert s 〉 + {e}^{\frac{i {ϕ}_{s}}{2}} sin \frac{{θ}_{s}}{2} \vert - s 〉 ) ( {e}^{- \frac{i {ϕ}_{l}}{2}} cos \frac{{θ}_{l}}{2} \vert l 〉 + {e}^{\frac{i {ϕ}_{l}}{2}} sin \frac{{θ}_{l}}{2} \vert - l 〉 )$$

offers only 4 free parameters (ϕ_{s,l} and θ_{s,l}) to be controlled, in contrast to 6 parameters required for a general SU(4) state. Therefore, non-separable states are the key to fully use the dimensionality of a high-dimensional Hilbert space and so is desired to exploit for the increase of the channel capacity for communications in both classical and quantum regimes.

Each chiral mode, either CW or CCW mode in one microring resonator, is directly coupled with both chiral modes in the other mirroring resonator via the two directional couplers (c₁ and c₂). As a result, the two chiral modes in the same microring resonator are also coupled with each other indirectly. For example, the CW mode in microring II is coupled with both CW and CCW modes in microring I as shown in FIG. 11. The CW wave in the left ring goes through waveguide 1 and c₁, and then it splits at c₂, coupling to the CW (CCW) wave via waveguide 3 (4). The coupling from the right ring to the left ring is similar, and in the end, we have the following two coupling paths from the CW wave in the left ring to the CCW wave in the same ring:

$${E}_{cw , I} \to {E}_{cw , II} \to {E}_{ccw , I} ,$$

$${E}_{cw , I} \to {E}_{ccw , II} \to {E}_{ccw , I} .$$

The same is true for the reversed coupling, i.e.,

$${E}_{ccw , I} \to {E}_{cw , II} \to {E}_{cw , I} ,$$

$${E}_{ccw , I} \to {E}_{ccw , II} \to {E}_{cw , I} .$$

Here, we discuss the results of our microlaser from the analytical model, given by the Hamiltonian previously. Below we first elucidate some properties of this Hamiltonian, including the symmetry of its eigenvalue spectrum. We rewrite the Hamiltonian as H=ω₀1+kH′, where wo is the degenerate ring resonance frequency in both rings, 1 is the identity matrix, k is the effective coupling strength between the two microrings, and

$${H}^{′} = [ \begin{matrix}2 {ig}^{′} & 0 & - i {c}_{13} & - {c}_{23} \\ 0 & 2 {ig}^{′} & {c}_{14} & - i {c}_{24} \\ - i {c}_{24} & - {c}_{23} & - 2 {ig}^{′} & 0 \\ c & - {ic}_{13} & 0 & - 2 {ig}^{′}\end{matrix} ] . \qquad ( S6 )$$

We note that H and H′ share the same eigenstates, and their eigenvalues are related by ∈ᵢ=ω₀+k∈ᵢ′ (i=1,2,3,4). Above 2ig′=(gᵣ+igᵢ)/k denotes the normalized complex frequency detuning between the two resonators, and we have used the notations cⱼ=e^{g}^{ⱼ}^{+iφ}^{ⱼ} and cⱼₖ=cⱼcₖ. The eigenvalues of H′ are surprisingly simple. We find that ∈′_{1,2}=±2ig′ and ∈′_{3,4}=±2i\sqrt{g′²+η²}, where η=eΣ^{j(gj+iφj)/2} is introduced in the main text. We operate in the parameter space, such as the lowest threshold mode is given by ∈′₄=−2i\sqrt{g′²+η²}, where the square root has a positive real part. The corresponding eigenstate is given in the main text, i.e., |Ψ [symbol] =[E_{II} rE_{I}]^{T}, where

$${E}_{I} = {[ {E}_{cw , I} {E}_{ccw , I} ]}^{T} = {[ - {ie}^{- \frac{{g}_{1} - {g}_{2}}{2} - i \frac{{φ}_{1} - {φ}_{2}}{2}} {e}^{\frac{{g}_{1} - {g}_{2}}{2} + i \frac{{φ}_{1} - {φ}_{2}}{2}} ]}^{T}$$

$${E}_{II} = {[ {E}_{cw , II} {E}_{ccw , II} ]}^{T} = {[ - {ie}^{\frac{{g}_{3} - {g}_{4}}{2} + i \frac{{φ}_{3} - {φ}_{4}}{2}} {e}^{- \frac{{g}_{3} - {g}_{4}}{2} - i \frac{{φ}_{3} - {φ}_{4}}{2}} ]}^{T}$$

are the wavefunctions in the two microrings, and

$$r = \frac{\sqrt{{g}^{′2} + {η}^{2}} + {g}^{′}}{η}$$

determines the latitude and longitude on HOPS III.

The observation that all eigenvalues of H′ appear in opposite pairs suggests a non-Hermitian chiral symmetry. By using the Clifford algebra and the Dirac matrices, i.e.,

$${γ}^{0} = [ \begin{matrix}{1}_{2} & \\ & - {1}_{2}\end{matrix} ] , {γ}^{j} = [ \begin{matrix} & {σ}_{j} \\ - {σ}_{j} & \end{matrix} ] ( j = 1 , 2 , 3 ) , {γ}^{5} = [ \begin{matrix} & {1}_{2} \\ {1}_{2} & \end{matrix} ]$$

where σⱼ are the Pauli matrices and 1₂ is the 2×2 identity matrix, we can express H′ as

$${H}^{′} = 2 {ig}^{′} {γ}^{0} - i {f}_{3} {γ}^{3} - i {f}_{5} {γ}^{5} + {γ}^{0} {γ}^{12} .$$

$$Here {f}_{3} = ( {c}_{13} - {c}_{24} ) / 2 , {f}_{5} = ( {c}_{13} + {c}_{24} ) / 2 , and$$

$${γ}^{12} = \frac{{c}_{14} - {c}_{23}}{2} {γ}^{1} - i \frac{{c}_{14} + {c}_{23}}{2} {γ}^{2} .$$

Using the anticommutation relations between the Dirac matrices and their product⁷, we identify γ¹² as the chiral operator in this case, i.e., {H′, γ¹²}=0. As a result, the eigenvalues of H′ appear in opposite pairs, and their eigenstates are related by γ¹² as well. For example, ψ₃=γ¹²ψ₄, which has non-zero amplitudes in both rings as well. ψ_{1/2}, however, are non-zero only in one of the two rings, respectively.

In FIGS. 3c and 3d, the pump in the two microrings are estimated to be roughly equal (gᵢ≈0), and we assume only the left ring close to pad 5 is detuned by heating, i.e., the (dimensionless) Hamiltonian H is replaced by

$${H}^{″} = [ \begin{matrix}0 & 0 & - {ic}_{13} & - {c}_{23} \\ 0 & 0 & {c}_{14} & - {ic}_{24} \\ - {ic}_{24} & - {c}_{23} & - 2 {g}_{r} / k & 0 \\ {c}_{14} & - {ic}_{13} & 0 & - 2 {g}_{r} / k\end{matrix} ] = {H}^{′} - \frac{{g}_{r}}{k} 1. \qquad ( S7 )$$

Eq. (S7) indicates that all ∈'s given previously are just shifted by −gᵣ/k in the complex plane. We then rewrite r=|r|e^{iϕ}=e^{iα}, where α∈C in general and ϕ=Re[α] is the longitude on HOPS III. Consequently, we find

$$sin α = - \frac{{g}_{r} / k}{2 η} . \qquad ( S8 )$$

Note that the two polar states on HOPS III, one from HOPS I and the other from HOPS II, are normalized to have the same intensity (i.e., I_{cw,I}+I_{ccw,I}=I_{cw,II}+I_{ccw,II}). The corresponding wavefunctions Er and En in the eigenstates of H (and H″), however, are not. Therefore, [r]=1 does not indicate that the state is on the equator of HOPS III. Instead, the relationship between |r| and the latitude on HOPS III (represented by θ₃) is given by

$$tan \frac{{θ}_{3}}{2} = \frac{1}{\vert r \vert} {( \frac{1 - {C}_{R}^{2}}{1 - {C}_{L}^{2}} )}^{\frac{1}{4}} . \qquad ( S9 )$$

Here C_{I/II} are the chirality in the two rings defined by

$${C}_{I / II} = \frac{{I}_{ccw , I / II} - {I}_{cw , I / II}}{{I}_{ccw , I / II} + {I}_{cw , I / II}} ,$$

and they can also be expressed as cos θ_{I/II} using the latitudes θ_{I/II} on HOPS I and II. From Eq. (S9), we know that only when |C_{II}|=|C_{I}| is a state with |r|=1 on the equator of HOPS III.

When |r|=1, or equivalently Im[α]=0, η then must be real from Eq. (S8), i.e., the sum of the accumulated phases in the four control arms are integer times of 2π:

$${\sum }_{j = 1}^{4} {φ}_{j} = 2 m π \\ ( m = 0 , 1 , 2 , … ) .$$

Now if we increase gᵣ/k from 0 to 2|η| to model the heat-induced frequency detuning between the two rings, α=ϕ then changes from 0 to π/2 (−π/2) when η is negative (positive). In the meanwhile, ∈′₄ remains imaginary except for the aforementioned shift −gᵣ/k in Eq. (S7), which then represents the only frequency shift caused by the heating. Because it is a tiny amount, this redshift in terms of the wavelength is also largely linear.

These trends are consistent with the experiment reported in FIG. 3c of the main text, although |r| there differs from 1 slightly (|r|26 1.35). To ensure the two rings have roughly equal intensity as in the experiment, we include a slight pump imbalance between the two rings while keeping η real (i.e., gᵢ/k≈−0.34η). The motion along the longitude of HOPS III and the wavelength shift are still qualitatively the same as the |r|=1 case and reproduces the trends observed in the experiment (FIG. 12). In the meanwhile, the eigenstate of H we consider here remains the one with the lowest threshold, as FIG. 12c shows. Note that the small but finite value of gᵢ smoothes out the exceptional point in all three panels of FIG. 12.

If we assume that gᵣ/k changes from −2|η| to 2|η| instead (i.e., there is some initial frequency detuning between the two rings before pad 5 is heated) in the case |r|=1, then we can tune ϕ on HOPS III by π. At gᵣ/k=±|η|, ∈′₄ (and ∈′₃) experiences an exceptional point, where these two modes coalesce. When we increase |gᵣ| beyond these two points, the relative phase between the two rings remains unchanged, which also holds qualitatively in the case shown in FIG. 12a. In the experiment, we could observe an even wider tuning range of the longitude on HOPS III, which might be ascribable to a heating-induced more complex and simultaneous change of parameters in the Hamiltonian than the one described above.

In FIG. 3d, the relative phase between the two rings displays jumps of roughly π. Our hypothesis is that this behavior may be attributed to “mode hopping”: By enforcing the sign convention that the square root \sqrt{g′²+η²} has a positive real part, the imaginary parts of ∈′_{3,4}=±2i\sqrt{g′²+η²} contact and then repel each other under certain conditions, instead of crossing each other (see FIG. 13c). At these points, they exchange identities, including their wavelengths and the relative phases between the two rings, resulting in jump-like behaviors that are qualitatively similar to the experimental data (see FIGS. 13a and 13b). In FIG. 13b the experimental data is shifted from our model, which could be attributed to the index change by the thermo-optical effect not considered in our model (to be discussed in the following sections), but a similar oscillation period as a function of gᵣ/k is clearly observed. The quasi-periodic nature of such jumps indicates an underlying oscillatory behavior, which could be attributed to the heating-induced index change in the control arms, leading to a periodic change in the phase of η (e.g., from 0 to 2π). This is the variation we use to produce the analytical results in FIG. 13. Note that the other modes 1 and 2 only have non-vanishing amplitudes in a single ring and different from the experiment observation. Therefore, they remain below threshold and are excluded from our consideration here.

Relative Phase Retrieval and Intensity Reconstruction on HOPS III from the Far-Field of the Spin-Orbit Microlaser

To demonstrate the phase control on an SU(4) Bloch hypersphere, we plot the tuning of the relative phase Δϕ between two microrings as a function of the heater's pumping power (FIG. 3c, 3d). In order to quantify and directly access Δϕ, we collect the emission from two microrings at the image plane (real space), Fourier transform (F) this emission by a lens, and study its far-field (k space) pattern at the lens' back focal plane. Specifically, if we denote electric fields of the left, right, and both rings at the image plane correspondingly as Eₗ, Eᵣ, and Eₗᵣ (assuming Eₗ and Eᵣ are centered at origin of the xy plane), then this process can be described by:

$$\text{Real space:} {E}_{lr} = {E}_{l} ( x , y ) δ ( x + d ) + {E}_{r} ( x , y ) δ ( x - d ) \\ ⇓ ℱ \\ k - \text{space:} {G}_{lr} = {e}^{{idk}_{x}} {G}_{l} ( {k}_{x} , {k}_{y} ) + {e}^{- {idk}_{x}} {G}_{r} ( {k}_{x} , {k}_{y} ) \qquad ( S10 )$$

with convolution [symbol] , Dirac delta function δ(x), center-to-center distance 2d between two rings, wave-vectors kₓ and k_{y} in k space, and Fourier transforms Gₗ, Gᵣ, and Gₗᵣ of Eₗ, Eᵣ, and Eₗᵣ, respectively. From Eq. S10, two counter-propagating waves will generate an interference fringe pattern in k space with intensity |Gₗᵣ|²:

$${\vert {G}_{lr} \vert}^{2} = {\vert {G}_{l} \vert}^{2} + {\vert {G}_{r} \vert}^{2} + {e}^{2 {idk}_{x}} {G}_{l} {G}_{r}^{*} + {e}^{- 2 {idk}_{x}} {G}_{l}^{*} {G}_{r} . \qquad ( S11 )$$

Now to retrieve the relative phase, we process this far-field intensity image digitally through the following three steps. We take the far-field image at 0 mW heater power as an example to demonstrate this processing sequence (FIG. 14a) corresponding to the result used for FIG. 3c in the main text. Eventually, we will show that the phase of GₗGᵣ* is the relative phase ϕ between two rings: ϕ=arg (GₗGᵣ*) or equivalently ϕ=−arg (Gₗ*Gᵣ), where arg( ) extracts the phase of a complex number.

First, we take the inverse Fourier transform ( [symbol] ⁻¹) of the fringe image |Gₗᵣ|². [symbol] ⁻¹{|Gₗᵣ|²} (FIG. 14b) allows us to spatially separate terms and select only one cross-correlation term on the right side of Eq. S11. For example

$${ℱ}^{- 1} \{ {e}^{2 {idk}_{x}} {G}_{l} {G}_{r}^{*} \} = 1 / 4 {π}^{2} {\int }_{- ∞}^{∞} {\int }_{- ∞}^{∞} ( {e}^{2 {idk}_{x}} \cdot {G}_{l} \cdot {G}_{r}^{*} \cdot {e}^{{ik}_{x} x + {ik}_{y} y} ) {dk}_{x} {dk}_{y} = δ ( x + 2 d ) {E}_{l} ( x , y ) , {E}_{r}^{*} ( - x , - y ) \qquad ( S12 )$$

will be centered at (−2d, 0). Similarly, [symbol] ⁻¹{e−^{2idk}^{ₓ}Gₗ*Gᵣ} will be shifted to (2d, 0), while [symbol] ⁻¹{|Gₗ|²+|Gᵣ|²} remains close to (0,0) because Eₗ and Eᵣ are centered at (0,0).

Second, we filter [symbol] ⁻¹{|Gₗᵣ|²} by a bandpass filter and shift the passband component to the origin. Specifically, as shown in FIG. 14b, we use a square window centered at (−2d, 0) to single out [symbol] ⁻¹{e^{2idk}^{ₓ}GₗGᵣ*} and shift it to (0,0):

$${I}_{BPs} = 6 ( x - 2 d ) {ℱ}^{- 1} \{ {e}^{2 {idk}_{x}} {G}_{l} {G}_{r}^{*} \} = {E}_{l} ( x , y ) {E}_{r}^{*} ( - x , - y ) , \qquad ( S13 )$$

where I_{BPs} is the bandpass-filtered then shifted electric field convolution. Finally, we Fourier transform I_{BPs} and extract the resultant pattern's intensity and phase: | [symbol] {I_{BPs}}|²=|GₗGᵣ*|² and arg ( [symbol] {I_{BPs}}) =arg (GₗGᵣ*) as shown in FIGS. 14c and 14d, respectively.

Note that the controlled frequency detuning between two microlasers facilitate phase tuning between HOPS I and II, thereby moving the 4D state in the longitude of HOPS III. Such phase tuning is reflected as the phase map shown in FIG. 14d rotating in the azimuthal direction. The reference point is the phase map without any power applied on heating pad 5.

### Experimental Retrieval and Calculation of the Density Matrix in the 4D Hilbert Space

To fully characterize the generated SU(4) states in the 4D Hilbert space, we experimentally retrieve the density matrix and calculate the quantum fidelity compared to its theoretical counterpart. For a single-mode coherent laser in our experiment, the emitted photon ensemble is in a pure state which can be expressed by the general form of the SU(4) state:

$$\vert ψ 〉 = β ( {re}^{i {ϕ}_{3}} ( a \vert + 2 , ↑ 〉 + {be}^{i {ϕ}_{1}} \vert - 2 , ↓ 〉 ) + ( c \vert - 2 , ↑ 〉 + {de}^{i {ϕ}_{2}} \vert \vert + 2 , ↓ 〉 ) ) , \qquad ( S14 )$$

where α|+2, ↑ [symbol] +be^{iϕ}^{₁}|−2, ↓ [symbol] and c|−2, ↑ [symbol] +de^{iϕ}^{₂}|+2, ↓ [symbol] are the emitted states from 2 individual rings, re^{iϕ}^{₃} are the relative complex coefficient between them, and β is the normalization factor. Therefore, the density matrix can be retrieved by measuring the complex coefficient associated with each eigen-basis. In the following, we use the iconic states described in FIG. 4:

$$\vert {ψ}_{1} 〉 = \frac{1}{2} ( \vert + 2 , ↑ > + \vert - 2 , ↓ > + \vert - 2 , ↑ > - \vert + 2 , ↓ > ) \\ and \\ \vert {ψ}_{2} 〉 = \sqrt{2} / 2 ( \vert + 2 , ↑ > - \vert - 2 , ↑ > )$$

as examples to show the density matrix is retrieved in details.

We first measure the emitted states from two individual rings. To do so, in experiments, we place a pin hole at the image plane of the sample to select one individual ring and then perform Stokes polarimetry as described in Methods and FIG. 8 to measure the relative amplitude and phase between the spin-up and spin-down components of the far field pattern from each ring at the Fourier plane, by which coefficients a, b, c, d in Eq. (S14) can be retrieved. For example, based on the measured data, for the high-dimensional superposition state |ψ₁ [symbol] , the emitted states from the left and right rings are 0.6708|+2, ↑ [symbol] +0.7416e^{-0.050πi}|−2, ↓ [symbol] and 0.7107|−2, ↑ [symbol] +0.7035e^{0.910πi}|+2, ↓ [symbol] , respectively. Similarly, for the other iconic state |ψ₂ [symbol] , the emitted states from the two rings are 0.9618|+2, ↑ [symbol] +0.2012e^{-0.400πi}|−2, ↓ [symbol] and 0.9823|−2, ↑ [symbol] +0.1871e−0.320πi|+2, ↓ [symbol] .

Next, the relative amplitude between emissions from two individual rings r can be straightforwardly retrieved by r=\sqrt{I₁/I₂}, where I₁ and I₂ are the total intensity of emissions from the two rings. The relative phase ϕ₃ can be reconstructed using the heterodyne method described in section 3 and FIG. 14. By using the process described above, the relative amplitude and phase are retrieved: r=1.0131, ϕ₃=−0.047π for |ψ₁ [symbol] and r=1.0835, ϕ₃=−0.915π for |ψ₂ [symbol] . After all the coefficients in Eq. (S14) are successfully retrieved in experiments, the reconstructed state vectors are:

$$\begin{matrix}{\vert {ψ}_{1} 〉}_{e xp} = {β}_{1} ( 1.0131 {e}^{- 0.047 π i} ( 0.6708 \vert + 2 , ↑ 〉 + 0.7416 {e}^{- 0.050 π i} \vert - 2 , ↓ 〉 ) + \\ ( 0.7107 \vert - 2 , ↑ 〉 + 0.7035 {e}^{0.910 π i} \vert + 2 , ↓ 〉 ) ) \\ = 0.4774 \vert + 2 , ↑ 〉 + 0.5278 {e}^{- 0.050 π i} \vert - 2 , ↓ 〉 + \\ 0. 4992 {e}^{0.047 π i} \vert - 2 , ↑ 〉 + 0.4942 {e}^{0.957 π i} \vert + 2 , ↓ 〉\end{matrix}$$

$$and$$

$$\begin{matrix}{\vert {ψ}_{2} 〉}_{e xp} = {β}_{2} ( 1.0835 {e}^{- 0.915 π i} ( 0.9618 \vert + 2 , ↑ 〉 + 0.2012 {e}^{- 0.400 π i} \vert - 2 , ↓ 〉 ) + \\ ( 0.9823 \vert - 2 , ↑ 〉 + 0.1871 {e}^{- 0.320 π i} \vert + 2 , ↓ 〉 ) ) \\ = 0.7068 \vert + 2 , ↑ 〉 + 0.2012 {e}^{- 0.4 π i} \vert - 2 , ↓ 〉 + \\ 0. 6663 {e}^{0.915 π i} \vert - 2 , ↑ 〉 + 0.1269 {e}^{0.595 π i} \vert + 2 , ↓ 〉\end{matrix}$$

After successfully reconstructing state vectors of the experimentally measured superposition states, the density matrix can then be calculated as:

$${{ρ}_{e xp} = \vert ψ 〉}_{e xp} 〈 ψ {\vert}_{e xp} .$$

Therefore, the density matrix of the high-dimensional superposition state |ψ₁ [symbol] can be conveniently calculated:

$$\begin{matrix}{{ρ}_{{1}_{e xp}} = \vert {ψ}_{1} 〉}_{e xp} 〈 {ψ}_{1} {\vert}_{e xp} \\ = [ \begin{matrix}0.4992 {e}^{0.047 π i} \\ 0.4942 {e}^{0.957 π i} \\ 0.4774 \\ 0.5278 {e}^{- 0.050 π i}\end{matrix} ] [ \begin{matrix}0.4992 {e}^{- 0.047 π i} & 0.4942 {e}^{- 0.957 π i} & 0.4774 & 0.5278 {e}^{0.0 \; 50 π i}\end{matrix} ] \\ = [ \begin{matrix}0.2492 & 0.2467 {e}^{- 0.91 π i} & 0.2383 {e}^{0.047 π i} & 0.2635 {e}^{0.097 π i} \\ 0.2467 {e}^{0.91 π i} & 0.2442 & 0.2359 {e}^{0.957 π i} & 0.2608 {e}^{1.007 π i} \\ 0.2383 {e}^{- 0.047 π i} & 0.2359 {e}^{- 0.957 π i} & 0.2279 & 0.252 {e}^{0.05 π i} \\ 0.2635 {e}^{- 0.097 π i} & 0.2608 {e}^{- 1.007 π i} & 0.252 {e}^{- 0.05 π i} & 0.2786\end{matrix} ]\end{matrix} ,$$

which is plotted as FIG. 4d, where the matrix element sequence is |+2, ↑ [symbol] , |−2, ↓>, |−2, ↑ [symbol] , |+2, ↓ [symbol] . Its corresponding theoretical density matrix can be easily obtained:

$${ρ}_{1 th} = [ \begin{matrix}0.25 & - 0.25 & 0.25 & 0.25 \\ - 0.25 & 0.25 & - 0.25 & - 0.25 \\ 0.25 & - 0.25 & 0.25 & 0.25 \\ 0.25 & - 0.25 & 0.25 & 0.25\end{matrix} ] ,$$

which is plotted as FIG. 4c. The fidelity of the experimental result with respect to its theoretical counterpart can be evaluated by

$$F ( {ρ}_{e xp} , {ρ}_{th} ) = {( Tr ( \sqrt{{ρ}_{e xp}^{\frac{1}{2}} {ρ}_{th} {ρ}_{e xp}^{\frac{1}{2}}} ) )}^{2} ,$$

which leads to F(β₁ₑₓₚ, β₁ₜₕ)=0.998 for the high-dimensional superposition state |ψ₁ [symbol] .

Similarly, the density matrix of state |ψ₂ [symbol] can be conveniently calculated, alongside its theoretical counterpart:

$$\begin{matrix}{{ρ}_{{2}_{e xp}} = \vert {ψ}_{2} 〉}_{e xp} 〈 {ψ}_{2} {\vert}_{e xp} \\ [ \begin{matrix}0.6663 {e}^{0.915 π i} \\ 0.1269 {e}^{0.595 π i} \\ 0.7068 \\ 0.2012 {e}^{- 0.4 π i}\end{matrix} ] [ \begin{matrix}0.6663 {e}^{- 0.915 π i} & 0.1269 {e}^{- 0.595 π i} & 0.7068 & 0.2012 {e}^{0.4 π i}\end{matrix} ] \\ [ \begin{matrix}0.444 & 0.0846 {e}^{0.32 π i} & 0.4709 {e}^{0.915 π i} & 0.1341 {e}^{1.315 π i} \\ 0.0846 {e}^{- 0.32 π i} & 0.0161 & 0.0897 {e}^{0.595 π i} & 0.0255 {e}^{0.995 π i} \\ 0.4709 {e}^{- 0.915 π i} & 0.0897 {e}^{- 0.595 π i} & 0.4996 & 0.1422 {e}^{0.4 π i} \\ 0.1341 {e}^{- 1.315 π i} & 0.0255 {e}^{- 0.995 π i} & 0.1422 {e}^{- 0.4 π i} & 0.0405\end{matrix} ]\end{matrix} ,$$

$$and$$

$${ρ}_{2 th} = [ \begin{matrix}0.5 & 0 & - 0.5 & 0 \\ 0 & 0 & 0 & 0 \\ - 0.5 & 0 & 0.5 & 0 \\ 0 & 0 & 0 & 0\end{matrix} ] ,$$

which are plotted as FIG. 4h and FIG. 4g in the main text, respectively. The corresponding fidelity can also be calculated: F(β₂ₑₓₚ>β₂ₜₕ)=0.942.

### Scalability of the Hyperdimensional Spin-Orbit Microlaser

Here, we would also like to note that our coupling strategy between microcavities is scalable. With more rings and coupled waveguides delicately arranged on-chip, more orders of OAM can be controlled to in principle further increase the dimensionality of the generated states. FIG. 13 shows the designs for three coupled and four coupled rings.

### EXEMPLARY EMBODIMENTS

The following embodiments are exemplary only and do not serve to limit the scope of the present disclosure of the appended claims. It should be understood that any part of any one or more Embodiments can be combined with any part of any other one or more Embodiments.

### Embodiment 1

A method comprising: generating, via a first microring of a microlaser, a first structured light emission having a first degree of freedom and a second degree of freedom; and generating, via a second microring of a microlaser, a second structured light emission having a third degree of freedom and a fourth degree of freedom, wherein an interaction between the first structured light emission and the second structured light emission forms a fifth degree of freedom.

### Embodiment 2

The method of Embodiment 1, wherein the first degree of freedom comprises an amplitude for the first structured light emission; the second degree of freedom comprises a phase for the first structured light emission; the third degree of freedom comprises an amplitude for the second structured light emission; and the fourth degree of freedom comprises a phase for the second structured light emission.

### Embodiment 3

The method of any of Embodiments 1 or 2, wherein the fifth degree of freedom comprises either a relative amplitude between the first structured light emission and the second structured light emission, or a relative phase between the first structured light emission and the second structured light emission.

### Embodiment 4

The method of any of Embodiments 1 through 3, wherein the interaction between the first structured light emission and the second structured light emission forms a sixth degree of freedom.

### Embodiment 5

The method of any of Embodiments 1 through 4, wherein the fifth degree of freedom comprises a relative amplitude between the first structured light emission and the second structured light emission, and the sixth degree of freedom comprises a relative phase between the first structured light emission and the second structured light emission.

### Embodiment 6

The method of any of Embodiments 1 through 5, further comprising: controlling the first degree of freedom, the second degree of freedom, the third degree of freedom, the fourth degree of freedom, or a combination thereof, via a plurality of waveguides.

### Embodiment 7

The method of any of Embodiments 1 through 6, further comprising: controlling the fifth degree of freedom via the controlling the first degree of freedom, the second degree of freedom, the third degree of freedom, the fourth degree of freedom, or any combination thereof, via the plurality of waveguides.

### Embodiment 8

The method of any of Embodiments 1 through 7, further comprising: controlling the first degree of freedom, the second degree of freedom, the third degree of freedom, the fourth degree of freedom, or a combination thereof, via one or more heating units associated with one or more of the first microring, the second microring, or a waveguide.

### Embodiment 9

The method of any of Embodiments 1 through 8, wherein the first structured light emission and the second structured light emission comprise spin-orbit-coupled states of light.

### Embodiment 10

The method of any of Embodiments 1 through 9, wherein the first structured light emission and the second structured light emission each comprise an infrared light emission.

### Embodiment 11

The method of any one of Embodiments 1-10, further comprising collecting any one or more of the first structured light emission, the second structured light emission, or a third structured light emission formed by an interaction between the first structured light emission and the second structured light emission.

### Embodiment 12

A device for generating hyperdimensional structured light, comprising: a first microring configured to generate a first structured light emission having a first degree of freedom and a second degree of freedom; and a second microring configured to generate a second structured light emission having a third degree of freedom and a fourth degree of freedom, wherein an interaction between the first structured light emission and the second structured light emission forms a fifth degree of freedom.

### Embodiment 13

The device of Embodiment 12, wherein: the first degree of freedom comprises an amplitude for the first structured light emission; the second degree of freedom comprises a phase for the first structured light emission; the third degree of freedom comprises an amplitude for the second structured light emission; and the fourth degree of freedom comprises a phase for the second structured light emission.

### Embodiment 14

The device of any one of Embodiments 12 or 13, wherein the fifth degree of freedom comprises either a relative amplitude between the first structured light emission and the second structured light emission, or a relative phase between the first structured light emission and the second structured light emission.

### Embodiment 15

The device of any one of Embodiments 12 through 14, wherein the interaction between the first structured light emission and the second structured light emission forms a sixth degree of freedom.

### Embodiment 16

The device of any of Embodiments 11 through 14, wherein the fifth degree of freedom comprises a relative amplitude between the first structured light emission and the second structured light emission, and the sixth degree of freedom comprises a relative phase between the first structured light emission and the second structured light emission.

### Embodiment 17

The device of any one of Embodiments 12 through 16, further comprising: a plurality of waveguides, wherein each of the plurality of waveguides is optically coupled to the first microring, the second microring, or both, and wherein controlling the first degree of freedom, the second degree of freedom, the third degree of freedom, the fourth degree of freedom, or a combination thereof, occurs via the plurality of waveguides.

### Embodiment 18

The device of any one of Embodiments 12 through 17, further comprising one or more directional couplers configured to optically couple the first microring and the second microring.

### Embodiment 19

The device of any of Embodiments 12 through 18, further comprising one or more heating units configured to control the first degree of freedom, the second degree of freedom, the third degree of freedom, the fourth degree of freedom, or a combination thereof.

### Embodiment 20

The device of any of Embodiments 12 through 19, wherein the first microring and the second microring are in proximity to each other.

### Embodiment 21

The device of any of Embodiments 12 through 20, wherein the device comprises a microlaser device configured for implementation in a communication system.

### Embodiment 22

The device of any one of Embodiments 12-21, further comprising a collector configured to collect any one or more of the first structured light emission, the second structured light emission, or a third structured light emission formed by an interaction between the first structured light emission and the second structured light emission.

### Embodiment 23

The device of any one of Embodiments 12-22, wherein the device is comprised on a chip.

### Embodiment 24

The device of Embodiment 23, wherein the first microring is configured to emit the first structured light emission substantially orthogonal to the chip.

### Embodiment 25

The device of Embodiment 23, wherein the second microring is configured to emit the second structured light emission substantially orthogonal to the chip.

1. A method, comprising:
generating, via a first microring of a microlaser, a first structured light emission having a first degree of freedom and a second degree of freedom; and
generating, via a second microring of a microlaser, a second structured light emission having a third degree of freedom and a fourth degree of freedom,
wherein an interaction between the first structured light emission and the second structured light emission forms a fifth degree of freedom.

2. The method of claim 1, wherein:
the first degree of freedom comprises an amplitude for the first structured light emission;
the second degree of freedom comprises a phase for the first structured light emission;
the third degree of freedom comprises an amplitude for the second structured light emission; and
the fourth degree of freedom comprises a phase for the second structured light emission.

3. The method of claim 1, wherein the fifth degree of freedom comprises either a relative amplitude between the first structured light emission and the second structured light emission, or a relative phase between the first structured light emission and the second structured light emission.

4. The method of claim 1, wherein the interaction between the first structured light emission and the second structured light emission forms a sixth degree of freedom.

5. The method of claim 4, wherein the fifth degree of freedom comprises a relative amplitude between the first structured light emission and the second structured light emission, and the sixth degree of freedom comprises a relative phase between the first structured light emission and the second structured light emission.

6. The method of claim 1, further comprising:
controlling the first degree of freedom, the second degree of freedom, the third degree of freedom, the fourth degree of freedom, or a combination thereof, via a plurality of waveguides.

7. The method of claim 6, further comprising:
controlling the fifth degree of freedom via the controlling the first degree of freedom, the second degree of freedom, the third degree of freedom, the fourth degree of freedom, or any combination thereof, via the plurality of waveguides.

8. The method of claim 6, further comprising:
controlling the first degree of freedom, the second degree of freedom, the third degree of freedom, the fourth degree of freedom, or any combination thereof, via one or more heating units associated with one or more of the first microring, the second microring, or a waveguide.

9. The method of claim 1, wherein the first structured light emission and the second structured light emission comprise spin-orbit-coupled states of light.

10. The method of claim 1, wherein the first structured light emission and the second structured light emission each comprise an infrared light emission.

11. The method of claim 1, further comprising collecting any one or more of the first structured light emission, the second structured light emission, or a third structured light emission formed by an interaction between the first structured light emission and the second structured light emission.

12. A device for generating hyperdimensional structured light, comprising:
a first microring configured to generate a first structured light emission having a first degree of freedom and a second degree of freedom; and
a second microring configured to generate a second structured light emission having a third degree of freedom and a fourth degree of freedom, wherein an interaction between the first structured light emission and the second structured light emission forms a fifth degree of freedom.

13. The device of claim 12, wherein:
the first degree of freedom comprises an amplitude for the first structured light emission;
the second degree of freedom comprises a phase for the first structured light emission;
the third degree of freedom comprises an amplitude for the second structured light emission; and
the fourth degree of freedom comprises a phase for the second structured light emission.

14. The device of claim 12, wherein the fifth degree of freedom comprises either a relative amplitude between the first structured light emission and the second structured light emission, or a relative phase between the first structured light emission and the second structured light emission.

15. The device of claim 12, wherein the interaction between the first structured light emission and the second structured light emission forms a sixth degree of freedom.

16. The device of claim 15, wherein the fifth degree of freedom comprises a relative amplitude between the first structured light emission and the second structured light emission, and the sixth degree of freedom comprises a relative phase between the first structured light emission and the second structured light emission.

17. The device of claim 12, further comprising:
at least one waveguide, wherein the at least one waveguide is optically coupled to the first microring, the second microring, or both, and wherein controlling the first degree of freedom, the second degree of freedom, the third degree of freedom, the fourth degree of freedom, or a combination thereof, occurs via the at least one waveguide.

18. The device of claim 12, further comprising one or more directional couplers configured to optically couple the first microring and the second microring.

19. (canceled)

20. (canceled)

21. The device of claim 12, wherein the device comprises a microlaser device configured for implementation in a communication system.

22. (canceled)

23. The device of claim 12, wherein the device is comprised on a chip.

24. (canceled)

25. (canceled)
